(19) United States
(12) Patent Application Publication
(10) Pub. No.: US 2013/0100888 A1
(43) Pub. Date: Apr. 25, 2013

(54) MOBILE COMMUNICATION SYSTEM, MOBILE STATION APPARATUS, BASE STATION APPARATUS, AND COMMUNICATION METHOD

(71) Applicants: Kazuyuki Shimezawa, Osaka-shi (JP); Tatsushi Aiba, Osaka-shi (JP)

(72) Inventors: Kazuyuki Shimezawa, Osaka-shi (JP); Tatsushi Aiba, Osaka-shi (JP)

(73) Assignee: SHARP KABUSHIKI KAISHA, Osaka-shi, Osaka (JP)

(21) Appl. No.: 13/704,898

(22) PCT Filed: Jun. 10, 2011
(86) PCT No.: PCT/JP2011/063414

§ 371 Date: Jan. 4, 2013

(30) Foreign Application Priority Data
Jun. 18, 2010 (JP) 2010-139053

(51) Int. Cl. H04W 72/04

(52) U.S. Cl. CPC H04W 72/0413
USPC 370/328

(57) ABSTRACT

In communication being performed complexly using a plurality of component carriers, a radio resource is efficiently used. A mobile communication system in which a base station apparatus and a mobile station apparatus communicate with each other through the use the plurality of component carriers, in which the base station apparatus sets a particular downlink component carrier to the mobile station apparatus, the mobile station apparatus selects a first arrangement method for uplink control information when only a physical downlink shared channel in the particular downlink component carrier is scheduled by the base station apparatus, and in which the mobile station apparatus selects a second arrangement method for the uplink control information when at least one of physical downlink shared channels in downlink component carriers other than the particular downlink component carrier is scheduled by the base station apparatus.

### TECHNICAL FIELD

The present invention relates to a mobile communication system and a communication method including a base station apparatus and a mobile station apparatus.

### BACKGROUND ART

A 3GPP (3rd Generation Partnership Project) is the project that performs examination/creation of specifications of a mobile communication system based on a network in which W-CDMA (Wideband-Code Division Multiple Access) and GSM (Global System for Mobile Communications) have been developed. In the 3GPP, a W-CDMA system is standardized as a third-generation cellular mobile communication system, and service thereof has been started sequentially. In addition, HSDPA (High-speed Downlink Packet Access) in which communication speed has been further increased is also standardized, and service thereof has been started. In the 3GPP, examination of a mobile communication system (hereinafter referred to as “LTE-A (Long Term Evolution-Advanced)” or “Advanced-EUTRA”) that realizes higher-speed data transmission and reception has been advanced utilizing evolution of a third-generation radio access technology (hereinafter referred to as “LTE (Long Term Evolution)” or “EUTRA (Evolved Universal Terrestrial Radio Access)”), and a wider frequency band.

As a communication system in the LTE, there have been examined an OFDMA (Orthogonal Frequency Division Multiple Access) system and an SC-FDMA (Single Carrier-Frequency Division Multiple Access) system which perform user multiplexing by using subcarriers perpendicular to each other. That is, there have been proposed in downlink, the OFDMA system that is a multi-carrier communication system and in uplink, the SC-FDMA system that is a single-carrier communication system.

Meanwhile, as a communication system in the LTE-A, in the downlink, the OFDMA system, and in the uplink, the introduction of a Clustered DFT-S-OFDM (also referred to as Discrete Fourier Transform Spread Orthogonal Frequency Division Multiplexing, DFT-S-OFDM with Spectrum Division Control, DFT-precoded OFDM, Clustered FDMA, or DFT-S-OFDM) system in addition to the SC-FDMA system have been examined. Here, in the LTE and LTE-A, the SC-FDMA system and the Clustered DFT-S-OFDM system which have been proposed as the uplink communication system have a feature in which a PAPR (Peak to Average Power Ratio: peak power to average power ratio or transmit power) in transmitting data (information) can be kept low due to characteristics of the single-carrier communication system and a communication system similar thereto (by single-career characteristics).

In addition, frequency bands used in a general mobile communication system are contiguous, whereas it has been examined that in the LTE-A, a contiguous and/or a non-contiguous plurality of frequency bands (hereinafter referred to as a “CC (Component Carrier)” or a “CC (Carrier Component)”) are complexly used to operate as one broadband frequency band (referred to as Carrier aggregation). Furthermore, it has also been proposed that a frequency band used for downlink communication and a frequency band used for uplink communication be set to have different frequency bandwidths (Asymmetric carrier aggregation) in order that a base station apparatus and a mobile station apparatus communicate with each other using the broadband frequency band (Non-Patent Document 1) more flexibly.

FIG. 9 is a diagram illustrating a mobile communication system in which carrier aggregation has been performed in a conventional technology. Setting a frequency band used for DL (Downlink) communication and a frequency band used for UL (Uplink) communication as shown in FIG. 9 to have a same bandwidth is also referred to as symmetric carrier aggregation. As shown in FIG. 9, the base station apparatus and the mobile station apparatus can communicate with each other in a broadband frequency band constituted by a plurality of CCs, by complexly using the plurality of CCs that is contiguous and/or non-contiguous frequency bands.

FIG. 9 shows that as an example, a frequency band used for downlink communication having a bandwidth of 100 MHz (hereinafter also referred to as a DL system band or a DL system bandwidth) is constituted by five DCCs (Downlink Component Carriers: DCC1, DCC2, DCC3, DCC4, and DCC5) having a bandwidth of 20 MHz. In addition, FIG. 9 shows that as an example, a frequency band used for uplink communication having the bandwidth of 100 MHz (hereinafter also referred to as a UL system band or a UL system bandwidth) is constituted by five UCCs (Uplink Component Carriers: UCC1, UCC2, UCC3, UCC4, and UCC5) having a bandwidth of 20 MHz.

In FIG. 9, in each DCC, downlink physical channels such as a Physical Downlink Control Channel (hereinafter, PDCCH) and a Physical Downlink Shared Channel (hereinafter, PDSCH) are arranged. The base station apparatus allocates DCI (Downlink Control Information) for transmitting the PDSCH to the mobile station apparatus through the use of the PDCCH, and transmits the PDSCH to the mobile station apparatus. That is, in FIG. 9, the base station apparatus can transmit a maximum of five PDSCHs (downlink transport blocks may be substituted) in a same subframe to the mobile station apparatus.

In addition, in each UCC, uplink physical channels such as a Physical Uplink Control Channel (hereinafter, PUCCH) and a Physical Uplink Shared Channel (hereinafter, PUSCH) are arranged. The mobile station apparatus transmits UCI (Uplink Control Information) to the base station apparatus through the use of the PUCCH and/or PUSCH. In addition, in FIG. 9, the mobile station apparatus can transmit a maximum of five PUSCHs (uplink transport blocks may be substituted) in a same subframe to the base station apparatus.

Similarly, FIG. 10 is a diagram illustrating a mobile communication system in which asymmetric carrier aggregation has been performed in the conventional technology. As shown in FIG. 10, the base station apparatus and the mobile station apparatus set the frequency band used for downlink communication and the frequency band used for uplink communication to have different bandwidths, complexly use the CCs that are the contiguous and/or non-contiguous frequency bands constituting these frequency bands, and thus can communicate with each other in a broadband frequency band.

FIG. 10 shows that as an example, a frequency band having the bandwidth of 100 MHz that is used for downlink communication is constituted by five DCCs (DCC1, DCC2, DCC3, DCC4, and DCC5) having the bandwidth of 20 MHz, and shows that a frequency band having a bandwidth of 40 MHz that is used for uplink communication is constituted by two UCCs (UCC1 and UCC2) having the bandwidth of 20 MHz.

Here, in FIG. 10, a downlink/uplink physical channel is arranged in each downlink/uplink CC, and the base station apparatus allocates the PDSCH to the mobile station apparatus through the use of the PDCCH, and transmits the PDSCH to the mobile station apparatus. That is, in FIG. 10, the base station apparatus can transmit a maximum of five PDSCHs (downlink transport blocks may be substituted) in a same subframe to the mobile station apparatus.

Furthermore, the mobile station apparatus transmits UCI to the base station apparatus through the use of the PUCCH and/or PUSCH. In addition, in FIG. 10, the mobile station apparatus can transmit a maximum of two PUSCHs (uplink transport blocks may be substituted) in a same subframe to the base station apparatus.

### PRIOR ART DOCUMENTS

### Non-Patent Document

Non-Patent Document 1: “Carrier aggregation in LTE-Advanced”, 3GPP TSG RAN WG1 Meeting #53bis, R1-082468, Jun. 30-Jul. 4, 2008.

### DISCLOSURE OF THE INVENTION

### Problem to be Solved by the Invention

However, there has been a problem in which in the conventional technology, the base station apparatus and the mobile station apparatus inefficiently use a radio resource in communicating with each other through the use of the plurality of CCs.

When the mobile station apparatus communicates with the base station apparatus through the use of the plurality of CCs, it is preferable to use an optimum transmission method for the UCI in the mobile communication system in which carrier aggregation has been performed. In contrast, the mobile station apparatus has to secure consistency with the transmission method for UCI in the conventional technology.

That is, in the conventional technology, the base station apparatus had to instruct the mobile station apparatus through the use of DCI whether to perform the optimum transmission method for the UCI in the mobile communication system in which carrier aggregation has been performed, or whether to perform the transmission method for the UCI in the conventional technology. That is, the base station apparatus and the mobile station apparatus have inefficiently used a radio resource in transmitting and receiving the UCI.

The present invention is made in view of such situations, and an object of the present invention is to provide a mobile communication system, a mobile station apparatus, a base station apparatus, and a communication method in which the base station apparatus and the mobile station apparatus can transmit and receive UCI efficiently using a radio resource in communicating with each other complexly using a plurality of CCs.

### Means for Solving the Problem

(1) In order to achieve the above-described object, the present invention has taken the following measures. That is, a mobile station apparatus of the present invention is the mobile station apparatus that transmits, to a base station apparatus through the use of a PUSCH, information indicating an ACK or NACK to a transport block transmitted by the base station apparatus, and the mobile station apparatus is characterized by including: a unit that selects a first information indicating ACK or NACK when the mobile station apparatus transmits, to the base station apparatus, the information indicating the ACK or NACK to the transport block transmitted in one CC; a unit that selects a second information indicating ACK or NACK when the mobile station apparatus transmits, to the base station apparatus, the information indicating the ACK or NACK with for the transport block transmitted in the plurality of CCs; and a unit that transmits, to the base station apparatus through the use of the PUSCH, the selected the first information indicating ACK or NACK or the selected the second information indicating ACK or NACK.

(2) In addition, a mobile station apparatus of the present invention is the mobile station apparatus that transmits, to a base station apparatus through the use of a PUSCH, information indicating an ACK or NACK to a transport block transmitted by the base station apparatus, and the mobile station apparatus is characterized by including: a unit that selects a first arrangement method when the mobile station apparatus transmits, to the base station apparatus, the information indicating the ACK or NACK to the transport block transmitted in one CC; a unit that selects a second arrangement method when the mobile station apparatus transmits, to the base station apparatus, the information indicating the ACK or NACK to the transport block transmitted in the plurality of CCs; a unit that processes the information indicating the ACK or NACK through the use of the selected first arrangement method or the selected second arrangement method; and a unit that transmits the processed information indicating the ACK or NACK to the base station apparatus through the use of the PUSCH.

(3) Furthermore, a base station apparatus of the present invention is the base station apparatus that receives from a mobile station apparatus through the use of a PUSCH information indicating an ACK or NACK to a transport block transmitted to the mobile station apparatus, and the base station apparatus is characterized by including: a unit that transmits the transport block to the mobile station apparatus in one CC or the plurality of CCs; a unit that selects a first information indicating ACK or NACK when the base station apparatus transmits the transport block to the mobile station apparatus in one CC; a unit that selects a second information indicating ACK or NACK when the base station apparatus transmits the transport block to the mobile station apparatus in the plurality of CCs; and a unit that receives from the mobile station apparatus through the use of the PUSCH the selected the first information indicating ACK or NACK or the selected the second information indicating ACK or NACK.

(4) Moreover, a base station apparatus of the present invention is the base station apparatus that receives from a mobile station apparatus through the use of a PUSCH information indicating an ACK or NACK to a transport block transmitted to the mobile station apparatus, and the base station apparatus is characterized by including: a unit that transmits the transport block to the mobile station apparatus in one CC or the plurality of CCs; a unit that selects a first arrangement method when the base station apparatus transmits the transport block to the mobile station apparatus in one CC; a unit that selects a second arrangement method when the base station apparatus transmits the transport block to the mobile station apparatus in the plurality of CCs; and a unit that receives from the mobile station apparatus through the use of the PUSCH the information indicating the ACK or NACK processed by the mobile station apparatus through the use of the selected first arrangement method or the selected second arrangement method.

(5) In addition, a mobile communication system of the present invention is the mobile communication system in which a base station apparatus and a terminal apparatus communicate with each other, and the mobile communication system is characterized in that the base station apparatus includes a unit that transmits a transport block to the mobile station apparatus in one CC or the plurality of CCs, and that the mobile station apparatus includes: a unit that selects a first information indicating ACK or NACK, which is the information indicating an ACK or NACK to the transport block transmitted in one CC, when the base station apparatus transmits the transport block for the mobile station apparatus in one CC; a unit that selects a second information indicating ACK or NACK, which is the information indicating the ACK or NACK to the transport block transmitted in the plurality of CCs, when the base station apparatus transmits the transport block for the mobile station apparatus in the plurality of CCs; and a unit that transmits, to the base station apparatus through the use of a PUSCH, the selected the first information indicating ACK or NACK or the selected the second information indicating ACK or NACK.

(6) Moreover, a mobile communication system of the present invention is the mobile communication system in which a base station apparatus and a terminal apparatus communicate with each other, and the mobile communication system is characterized in that the base station apparatus includes a unit that transmits a transport block to the mobile station apparatus in one CC or the plurality of CCs, and that the mobile station apparatus includes: a unit that selects a first arrangement method when the base station apparatus transmits the transport block for the mobile station apparatus in one CC; a unit that selects a second arrangement method when the base station apparatus transmits the transport block for the mobile station apparatus in the plurality of CCs; a unit that processes information indicating an ACK or NACK to the transport block through the use of the selected first arrangement method or the selected second arrangement method; and a unit that transmits the processed information indicating the ACK or NACK to the base station apparatus through the use of the PUSCH.

(7) Furthermore, a communication method of the present invention is the communication method for a mobile station apparatus that transmits, to a base station apparatus through the use of a PUSCH, information indicating an ACK or NACK to a transport block transmitted by the base station apparatus, and the communication method is characterized in that the mobile station apparatus selects a first information indicating ACK or NACK when transmitting, to the base station apparatus, the information indicating the ACK or NACK to the transport block transmitted in one CC, the mobile station apparatus selects a second information indicating ACK or NACK when transmitting, to the base station apparatus, the information indicating the ACK or NACK to the transport block transmitted in the plurality of CCs, and that the mobile station apparatus transmits, to the base station apparatus through the use of the PUSCH, the selected the first information indicating ACK or NACK or the selected the second information indicating ACK or NACK.

(8) In addition, a communication method of the present invention is the communication method for a mobile station apparatus that transmits, to a base station apparatus through the use of a PUSCH, information indicating an ACK or NACK to a transport block transmitted by the base station apparatus, and the communication method is characterized in that the mobile station apparatus selects a first arrangement method when transmitting, to the base station apparatus, the information indicating the ACK or NACK to the transport block transmitted in one CC, the mobile station apparatus selects a second arrangement method when transmitting, to the base station apparatus, the information indicating the ACK or NACK to the transport block transmitted in the plurality of CCs, and that the mobile station apparatus processes the information indicating the ACK or NACK through the use of the selected first arrangement method or the selected second arrangement method, and transmits the processed information indicating the ACK or NACK to the base station apparatus through the use of the PUSCH.

### Effects of the Invention

According to the present invention, a base station apparatus and a mobile station apparatus can transmit and receive UCI efficiently through the use of a radio resource in communicating with each other complexly through the use of a plurality of CCs.

### BRIEF DESCRIPTION OF THE DRAWINGS

FIG. 1 is a diagram conceptually showing a configuration of a physical channel pertaining to an embodiment of the present invention;

FIG. 2 is a block diagram showing a schematic configuration of a base station apparatus 100 pertaining to the embodiment of the present invention;

FIG. 3 is a block diagram showing a schematic configuration of a mobile station apparatus 200 pertaining to the embodiment of the present invention;

FIG. 4 is a diagram showing an example of a mobile communication system to which the embodiment of the present invention can be applied;

FIG. 5 is a diagram showing a physical uplink resource;

FIG. 6 is a diagram showing an example of a mapping method for UCI;

FIG. 7 is an another diagram showing an example of a mapping method of the UCI;

FIG. 8 is a still another diagram showing an example of a mapping method of the UCI;

FIG. 9 is a diagram showing an example of carrier aggregation in a conventional technology; and

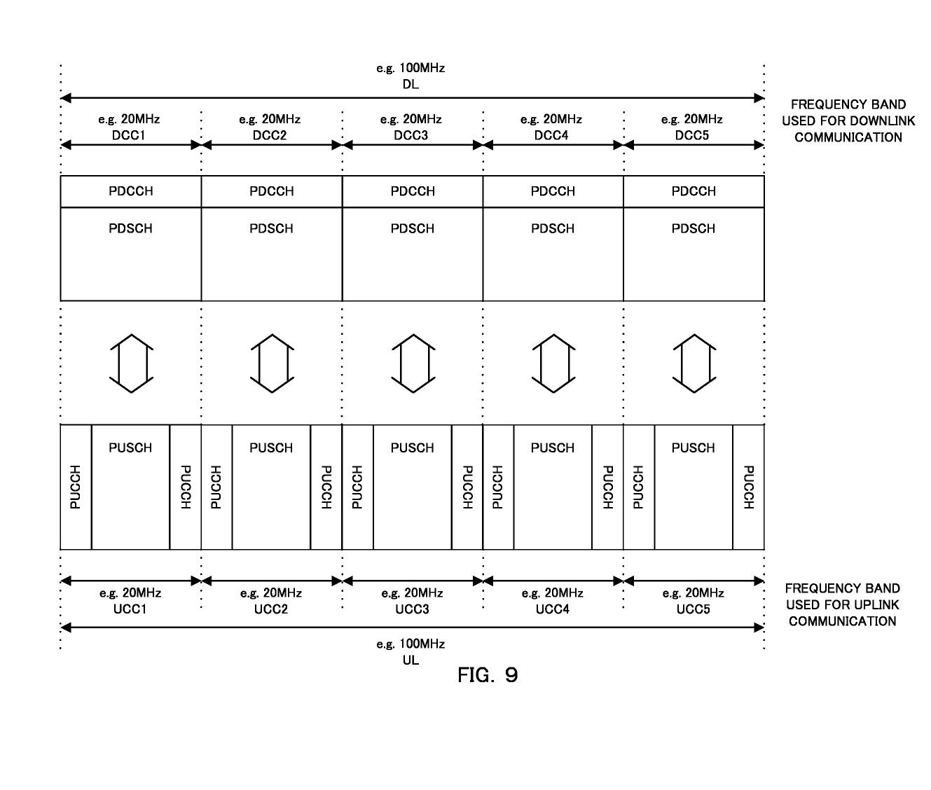

FIG. 10 is a diagram showing an example of asymmetric carrier aggregation in the conventional technology.

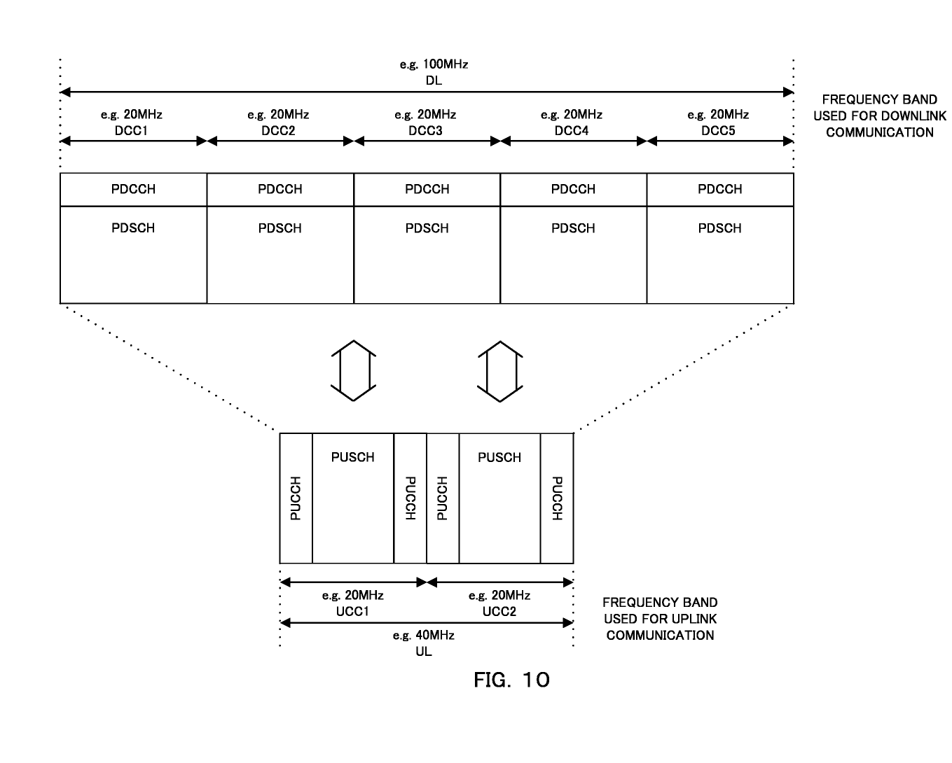

### EMBODIMENTS OF THE INVENTION

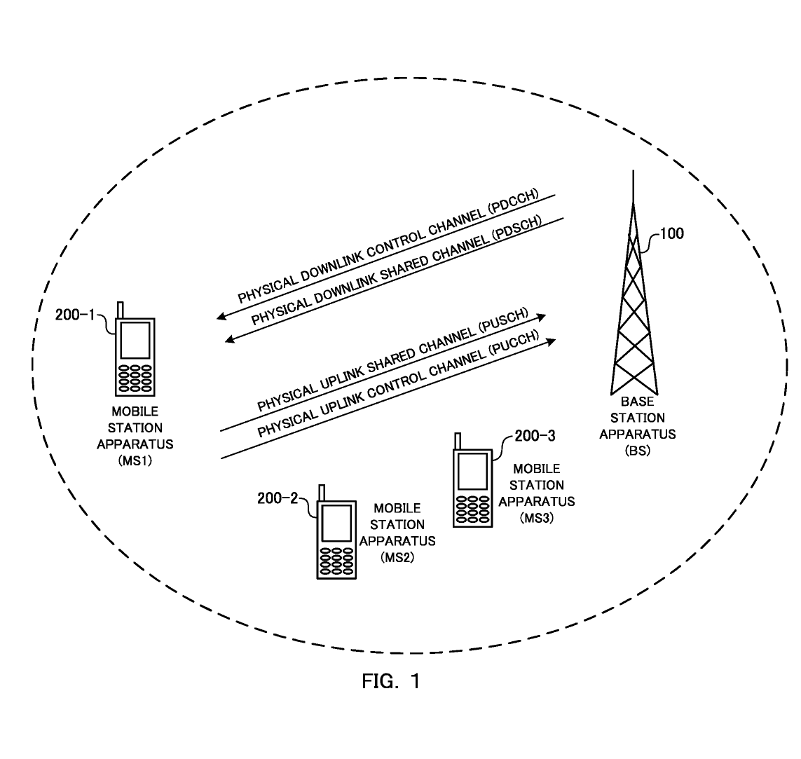

Next, an embodiment pertaining to the present invention will be described with reference to drawings. FIG. 1 is a diagram showing a configuration example of a channel in the embodiment of the present invention. A communication system pertaining to the present invention is constituted by including a base station apparatus 100 (a downlink transmission apparatus, an uplink reception apparatus, an eNodeB, a BS (Base Station), and a cell), and mobile station apparatuses 200-1 to 200-3 (a downlink reception apparatus, an uplink transmission apparatus, a terminal apparatus, UE (User Equipment), and an MS (Mobile Station)) (hereinafter, the mobile station apparatuses 200-1 to 200-3 are collectively referred to as a mobile station apparatus 200). In addition, a downlink physical channel is constituted by a PDCCH (Physical Downlink Control Channel), a PDSCH (Physical Downlink Shared Channel), etc. An uplink physical channel is constituted by a PUSCH (Physical Uplink Shared Channel), a PUCCH (Physical Uplink Control Channel), etc.

The PDCCH is a channel used in order to notify (specify) the mobile station apparatus 200 of resource allocation of the PDSCH, HARQ processing information for downlink data, and resource allocation of the PUSCH, etc. The PDCCH is constituted by a plurality of CCEs (Control Channel Element), and the mobile station apparatus 200 receives the PDCCH from the base station apparatus 100 by detecting the PDCCH constituted by the CCEs.

This CCE is constituted by a plurality of REGs (Resource Element Groups, which are also referred to as mini-CCEs) that is distributed in frequency and time domains. Here, a resource element means a unit resource constituted by one OFDM symbol (time component) and one subcarrier (frequency component), and for example, the REG is constituted by four downlink resource elements contiguous in a frequency domain except for a downlink reference signal in the frequency domain in a same OFDM symbol. For example, one PDCCH is constituted by one, two, four, or eight CCEs having successive numbers for identifying the CCEs (CCE indices).

Here, separate coding of the PDCCHs is performed for each mobile station apparatus 200 and each type thereof. That is, the mobile station apparatus 200 detects the plurality of PDCCHs, and obtains downlink or uplink resource allocation and other control information. A value of CRC (cyclic redundancy check)) is given to each PDCCH, and the mobile station apparatus 200 checks the CRC for each sets of CCEs with which the PDCCH may be constituted, and can obtain the PDCCH in which the CRC has been succeeded. This is also referred to as blind decoding, and a range of the set of CCEs with which the PDCCH to which the mobile station apparatus 200 performs blind decoding may be constituted is referred to as a search space. That is, the mobile station apparatus 200 performs blind decoding to the CCEs in the search space, and detects the PDCCH.

Here, the search space in which the mobile station apparatus 200 tries search (detection) of the PDCCH addressed to the mobile station apparatus 200 itself includes a CSS (Common Search Space) in which the plurality of mobile station apparatuses 200 tries search of the PDCCH, and a USS (User equipment specific Search Space or a UE specific Search Space) in which a (particular) mobile station apparatus 200 tries search of the PDCCH. The base station apparatus 100 can arrange the PDCCH in the CSS (Common Search Space). In addition, the base station apparatus 100 can arrange the PDCCH in the USS (User equipment specific Search Space).

When resource allocation of the PDSCH is included in the PDCCH, the mobile station apparatus 200 receives data (hereinafter also referred to as a downlink signal) (downlink data (DL-SCH (Downlink Shared Channel)) and/or downlink control data (DCI)) through the use of the PDSCH in accordance with the resource allocation instructed by the PDCCH from the base station apparatus 100. That is, this PDCCH is a signal (hereinafter also referred to as a “downlink transmission permission signal” or a “downlink grant”) that performs resource allocation to the downlink.

In addition, when resource allocation of the PUSCH is included in the PDCCH, the mobile station apparatus 200 transmits data (hereinafter also referred to as an uplink signal) (uplink data (UL-SCH (Uplink Shared Channel)) and/or uplink control data (UCI)) through the use of the PUSCH in accordance with the resource allocation instructed by the PDCCH from the base station apparatus 100. That is, this PDCCH is a signal (hereinafter also referred to as an “uplink transmission permission signal” or an “uplink grant”) that permits data transmission to the uplink.

The PDSCH is a channel used to transmit the downlink data (DL-SCH (Downlink Shared Channel)) or paging information (PCH (paging channel)). A PMCH is a channel utilized to transmit an MCH (Multicast Channel), in which a downlink reference signal, an uplink reference signal, and a physical downlink synchronization signal are arranged separately.

Here, the downlink data (DL-SCH), for example, indicates transmission of user data, and the DL-SCH is a transport channel. In the DL-SCH, an HARQ and dynamic adaptation radio link control are supported, and beamforming can be utilized. In the DL-SCH, dynamic resource allocation and quasi static resource allocation are supported.

The PUSCH is a channel mainly used to transmit uplink data (UL-SCH (Uplink Shared Channel)). In addition, when the base station apparatus 100 performs scheduling of the mobile station apparatus 200, UCI is also transmitted using the PUSCH. In the UCI, there are included feedback information based on a state (status) of a downlink channel (transmission channel, transmission path, or communication path), and control information in the HARQ (Hybrid Automatic Repeat reQuest). Here, the feedback information means recommended transmission format information (implicit channel state information) to the base station, and information indicating a channel state (explicit channel state information).

Specifically, in the feedback information, information is included indicating CSI (Channel State Information or Channel Statistical Information) indicating a downlink channel state, a downlink CQI (Channel Quality Indicator), a PMI (Precoding Matrix Indicator), and an RI (rank indicator).

In addition, in control information in the HARQ, included are information indicating an ACK (Acknowledgement)/NACK (Negative Acknowledgement) and/or information indicating a DTX for the PDCCH and/or a downlink transport block that are transmitted from the base station apparatus 100. Here, the information indicating the DTX is the information indicating that the mobile station apparatus 200 has not been able to detect the PDCCH transmitted from the base station apparatus 100 (it may be the information indicating whether or not the mobile station apparatus 200 has been able to detect the PDCCH).

Here, feedback information will be described in detail. Feedback information indicates the information indicating a channel state for a downlink signal transmitted to the base station apparatus 100 from the mobile station apparatus 200. For example, the mobile station apparatus 200 measures (calculates or generates) the channel state for the downlink signal based on downlink measurement reference signals (CSI-RS (Reference Signal), a CRS (Cell-specific RS), a base station apparatus 100-specific reference signal, a cell-specific reference signal, a feedback information measurement reference signal) transmitted from the base station apparatus 100, and transmits it (report it or feed it back) to the base station apparatus 100 as feedback information. Here, the reference signal is a mutually known signal (information) in the base station apparatus 100 and the mobile station apparatus 200.

The base station apparatus 100 can perform various adaptive control to the mobile station apparatus 200 based on the feedback information from the mobile station apparatus 200. First, when recommended transmission format information to the base station is used as the feedback information, assuming that a known transmission format is previously indexed (made into a codebook) in both the base station apparatus 100 and the mobile station apparatus 200, the mobile station apparatus 200 feeds back the information using the transmission format, and the base station apparatus 100 performs adaptive control through the use of the information.

Specifically, the CQI is information indicating a coding rate and a modulation scheme. The base station apparatus 100 can control coding processing and modulation processing based on the CQI fed back from the mobile station apparatus 200. The adaptive control of the coding rate and the modulation scheme by the base station apparatus 100 allows the optimum data transmission in accordance with a reception quality in the mobile station apparatus 200.

In addition, the PMI is information indicating a precoding matrix (a precoding weight or a precoding vector).

The base station apparatus 100 can control precoding processing based on the PMI fed back from the mobile station apparatus 200. The base station apparatus 100 can improve the reception quality in the mobile station apparatus 200 by performing adaptive control of the precoding matrix. Here, precoding means processing, such as phase rotation and weighting processing to a signal sent from a transmission antenna of the base station apparatus 100.

In addition, the RI is information indicating the number of spatial multiplexing (the number of layers, the number of ranks) of SDM (Space Division Multiplexing) utilizing MIMO (Multiple Input Multiple Output).

The base station apparatus 100 can control layer mapping processing and processing of a higher layer that generates a code word in the base station apparatus 100 based on the RI fed back from the mobile station apparatus 200. The base station apparatus 100 performs adaptive control of the number of spatial multiplexing, and thus the optimum data transmission in accordance with the reception quality in the mobile station apparatus 200 can be performed. In addition, when feedback information on mapping to a resource is also included, resource element mapping processing in the base station apparatus 100 can also be controlled.

Furthermore, the PMI can also be classified into a plurality of types in accordance with a method, an object, an application of data transmission, etc. For example, the PMI can be classified into a PMI1 indicating a broadband precoding matrix W1 and a PMI2 indicating a narrowband precoding matrix W2. That is, in the PMI, included are the PMI1 indicating the broadband precoding matrix W1 and the PMI2 indicating the narrowband precoding matrix W2.

Here, the broadband precoding matrix W1 can be set as a precoding matrix in a frequency bandwidth constituting a system bandwidth and a CC. In addition, the narrowband precoding matrix W2 is a precoding matrix in a same bandwidth as a frequency bandwidth indicated by the broadband precoding matrix or in a bandwidth narrower than it, and can be, for example, set as a precoding matrix in a BW part (Bandwidth) part) and a subband that are constituted by at least one resource block.

Here, the PMI1 can also be set as precoding information for a long term (long interval). In addition, the PMI2 can also be set as precoding information for a short term (short interval).

Hereinafter, will be more specifically described precoding processing based on the broadband precoding information PMI1 and the narrowband precoding information PMI2, and the broadband precoding matrix W1 indicated by the PMI1 and the narrowband precoding matrix W2 indicated by the PMI2.

First, a system (between the base station apparatus 100 and the mobile station apparatus 200) fixes to express a preferred precoder F as F=A(i)B(j). In addition, the W1 and W2 are made into code books as A and B, respectively, and indices i and j thereof are reported as the PMI1 and PMI2.

For example, the W1 and W2 are prescribed as sixteen types of A(i) and B (j), respectively, and 4 bits of PMI1 and PMI2 are reported as feedback information. Here, F is a matrix of a size of the number of layers by the number of antenna ports, and A and B are predetermined sizes of matrices. However, the matrix herein is a concept including a vector or a scalar. As A and B, there can be used arbitrary matrices uniquely determined by, for example, specifying the following i and j.

(1) Assume that A (i)=Wi and B(j)=V1+V2φj hold.

Here, V1 and V2 are predetermined matrices constituted by elements of 0 and 1, Wi is a matrix specified by a predetermined code book, and φj is a scalar specified with a predetermined code book.

(2) Assume that A(i)=Wi and B (j)=φj hold. Here, Wi and φj are matrices specified by predetermined code books.

(3) Assume that A(i)=[Wi Wi] and B(j)=φj hold. Here, Wi and φj are matrices specified by the predetermined code books.

(4) Assume that A(i)=K (U, Wi) and B(j)=[I φjT] T hold.

Here, U is a predetermined matrix, I is a unit matrix, and Wi and φj are matrices specified by the predetermined code books. In addition, K (X, Y) is a Kronecker product of matrices X and Y, and XT is an operator indicating a transposed matrix of the matrix X.

As described above, a preferred precoder expressed using the PMI1 and PMI2 can be expressed as a precoder in which a precoder expressed by the PMI1 and a precoder expressed by the PMI2 are coupled to each other. It should be noted that here will be described a case where the system has fixed to express as F=A(i)B(j) as coupling of the precoders, but that a similar effect can be obtained even if an other coupling method of the precoders is fixed by the system, such as in a case of expressing as F=K(A (i), B(j)).

Next, in the case of information indicating a channel state as the feedback information, the mobile station apparatus 200 feeds back the information on the state of the channel to the base station apparatus 100, through the use of a base station apparatus-specific reference signal from the base station apparatus 100. At that time, an amount of information can also be reduced using various methods, such as eigenvalue decomposition and quantization. In the base station, control on the mobile station apparatus 200 is performed using the fed-back information on the channel state. For example, in the base station apparatus 100, the coding rate and modulation scheme, the number of layers, and the precoding matrix can be determined so that the optimum reception can be performed at the time of reception in the mobile station apparatus 200 based on the fed-back information, and various methods can be used for the determination.

Here, the uplink data (UL-SCH), for example, means transmission of user data, and the UL-SCH is a transport channel. In the UL-SCH, an HARQ and dynamic adaptation radio link control are supported, and beamforming can be utilized. In the UL-SCH, dynamic resource allocation and quasi static resource allocation are supported.

In addition, in the uplink data (UL-SCH) and downlink data (DL-SCH), there may be included a radio resource control signal (hereinafter referred to as “RRC signaling (Radio Resource Control Signaling)”), an MAC (Medium Access Control) control element and the like, which are exchanged between the base station apparatus 100 and the mobile station apparatus 200.

The base station apparatus 100 and the mobile station apparatus 200 transmit and receive the RRC signaling in a higher layer (radio resource control layer). In addition, the base station apparatus 100 and the mobile station apparatus 200 transmit and receive the MAC control element in a higher layer (MAC (Medium Access Control) layer).

The PUCCH is a channel used for transmitting the UCI. Here, in the UCI, for example, included are the channel state information CSI indicating the downlink channel state, the downlink channel quality indicator CQI, the precoding matrix indicator PMI, the rank indicator RI, an SR (scheduling request) that requests resource allocation for the mobile station apparatus 200 to transmit the uplink data (requests transmission in the UL-SCH), and control information in the HARQ.

[Configuration of Base Station Apparatus 100]

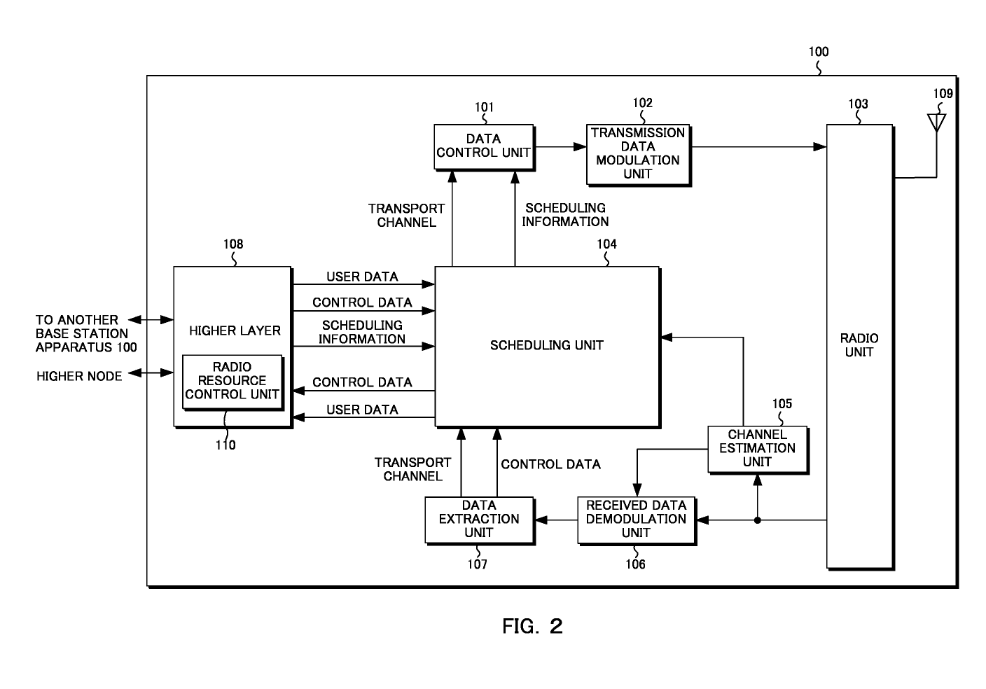

FIG. 2 is a block diagram showing a schematic configuration of the base station apparatus 100 pertaining to the embodiment of the present invention. The base station apparatus 100 is constituted by including a data control unit 101, a transmission data modulation unit 102, a radio unit 103, a scheduling unit 104, a channel estimation unit 105, a received data demodulation unit 106, a data extraction unit 107, a higher layer 108, and an antenna 109. In addition, a reception unit is constituted by the radio unit 103, the scheduling unit 104, the channel estimation unit 105, the received data demodulation unit 106, the data extraction unit 107, the higher layer 108, and the antenna 109, and a transmission unit is constituted by the data control unit 101, the transmission data modulation unit 102, the radio unit 103, the scheduling unit 104, the higher layer 108, and the antenna 109.

Processing of an uplink physical layer is performed by the antenna 109, the radio unit 103, the channel estimation unit 105, the received data demodulation unit 106, and the data extraction unit 107. Processing of a downlink physical layer is performed by the antenna 109, the radio unit 103, the transmission data modulation unit 102, and the data control unit 101.

The data control unit 101 receives a transport channel from the scheduling unit 104. The data control unit 101 maps the transport channel, and a signal and a channel that are generated in the physical layer into a physical channel based on scheduling information input from the scheduling unit 104. Each mapped data as described above is output to the transmission data modulation unit 102.

The transmission data modulation unit 102 modulates transmission data to an OFDM signal. The transmission data modulation unit 102 performs signal processing, such as data modulation, coding, series/parallel conversion of the input signal, IFFT (Inverse Fast Fourier Transform) processing, CP (Cyclic Prefix) insertion, and filtering with respect to the data input from the data control unit 101 based on the scheduling information from the scheduling unit 104, and a modulation scheme and a coding scheme corresponding to each PRB, generates transmission data, and outputs it to the radio unit 103.

Here, in the scheduling information, included is downlink PRB (Physical Resource Block) allocation information, such as a PRB position information constituted by a frequency and time, and in the modulation scheme and coding rate corresponding to each PRB, included is information, such as a 16QAM modulation scheme, a 2/3 coding rate.

The radio unit 103 up-converts the modulation data input from the transmission data modulation unit 102 into a radio frequency to thereby generate a radio signal, and transmits it to the mobile station apparatus 200 via the antenna 109. In addition, the radio unit 103 receives the uplink radio signal from the mobile station apparatus 200 via the antenna 109, down-converts it into a baseband signal, and outputs the received data to the channel estimation unit 105 and the received data demodulation unit 106.

The scheduling unit 104 performs processing of an MAC (Medium Access Control) layer. The scheduling unit 104 performs mapping of a logical channel and a transport channel, downlink and uplink scheduling (HARQ processing, selection of a transport format, etc.) etc. In the scheduling unit 104, in order to integrally control a processing unit of each physical layer, there exist the scheduling unit 104, the antenna 109, the radio unit 103, the channel estimation unit 105, the received data demodulation unit 106, the data control unit 101, an interface between the transmission data modulation unit 102 and the data extraction unit 107 (however, not shown).

The scheduling unit 104, in the downlink scheduling, performs selection processing of a downlink transport format (transmission form, i.e., PRB allocation, a modulation scheme, a coding scheme, etc.) for modulating each data, retransmission control in the HARQ, and generation of scheduling information used for the downlink, based on the feedback information (uplink feedback information (CSI, CQI, PMI, and RI), ACK/NACK information for the downlink data, etc.) received from the mobile station apparatus 200, information on a PRB capable of being used by each mobile station apparatus 200, a buffer status, scheduling information input from the higher layer 108, and the like. The scheduling information used for the downlink scheduling is output to the data control unit 101.

In addition, the scheduling unit 104, in the uplink scheduling, performs selection processing of an uplink transport format (transmission form, i.e., PRB allocation, a modulation scheme, a coding scheme, etc.) for modulating each data, and generates scheduling information used for the uplink scheduling, based on an estimation result of a channel state for uplink measurement that is output by the channel estimation unit 105, a resource allocation request from the mobile station apparatus 200, information on the PRB capable of being used by each mobile station apparatus 200, the scheduling information input from the higher layer 108, and the like. The scheduling information used for the uplink scheduling is output to the data control unit 101.

Moreover, the scheduling unit 104 maps the downlink logical channel input from the higher layer 108 into the transport channel, and outputs it to the data control unit 101. In addition, after processing the control data and the transport channel which have been input from the data extraction unit 107 and which have been obtained in the uplink if needed, the scheduling unit 104 maps them into the uplink logical channel, and outputs them to the higher layer 108.

The channel estimation unit 105, for demodulation of the uplink data, estimates a channel state for uplink demodulation from uplink demodulation reference signals (a DMRS (Demodulation Reference Signal) and a DRS (Dedicated RS)), and outputs the estimation result to the received data demodulation unit 106. Furthermore, in order to perform uplink scheduling, the channel estimation unit 105 estimates a channel state for uplink measurement (for adaptive control) from an uplink SRS (Sounding Reference Signal), and outputs the estimation result to the scheduling unit 104.

Here, the uplink demodulation reference signal is an independent reference signal for each data (layer and rank) spatially multiplexed by the mobile station apparatus 200, and the base station apparatus 100 estimates a channel state for each spatially multiplexed data. In addition, the uplink measurement reference signal is an independent reference signal for each antenna port of the mobile station apparatus 200, and the base station apparatus 100 estimates a channel state for each antenna port.

The received data demodulation unit 106 doubles a DFT-Spread-OFDM demodulation unit that demodulates received data modulated to a DFT-Spread-OFDM (SC-FDMA) signal. The received data demodulation unit 106 performs signal processing, such as DFT conversion, subcarrier mapping, IFFT conversion, and filtering with respect to the modulation data input from the radio unit 103 based on the estimation result of the uplink channel state input from the channel estimation unit 105, applies demodulation processing, and outputs it to the data extraction unit 107.

The data extraction unit 107 confirms truth or error of the data input from the received data demodulation unit 106, and also outputs a confirmation result (acknowledgment signal ACK/non-acknowledgment signal NACK) to the scheduling unit 104. In addition, the data extraction unit 107 separates the data input from the received data demodulation unit 106 into the transport channel and the physical layer control data, and outputs them to the scheduling unit 104. In the separated control data, there are included the channel state information CSI, the downlink channel quality indicator CQI, the precoding matrix indicator PMI, the rank indicator RI, control information in the HARQ, SR, etc which the mobile station apparatus 200 has provided notification of.

The higher layer 108 performs processing of a PDCP (Packet Data Convergence Protocol) layer, an RLC (Radio Link Control) layer, and an RRC (Radio Resource Control) layer. In the higher layer 108, in order to integrally control processing units of physical layers, there exist the higher layer 108, the scheduling unit 104, the antenna 109, the radio unit 103, the channel estimation unit 105, the received data demodulation unit 106, the data control unit 101, the interface between the transmission data modulation unit 102 and the data extraction unit 107 (however, not shown).

The higher layer 108 has a radio resource control unit 110 (also referred to as a control unit). In addition, the radio resource control unit 110 performs management of various setting information, management of system information, paging control, management of a communication state of each mobile station apparatus 200, mobile management, such as handover, management of a buffer status for each mobile station apparatus 200, management of connection setting of unicast and multicast bearers, management of a UEID (mobile station indicator), etc. The higher layer 108 gives and receives information to/from another base station apparatus 100 and a higher node.

[Configuration of Mobile Station Apparatus 200]

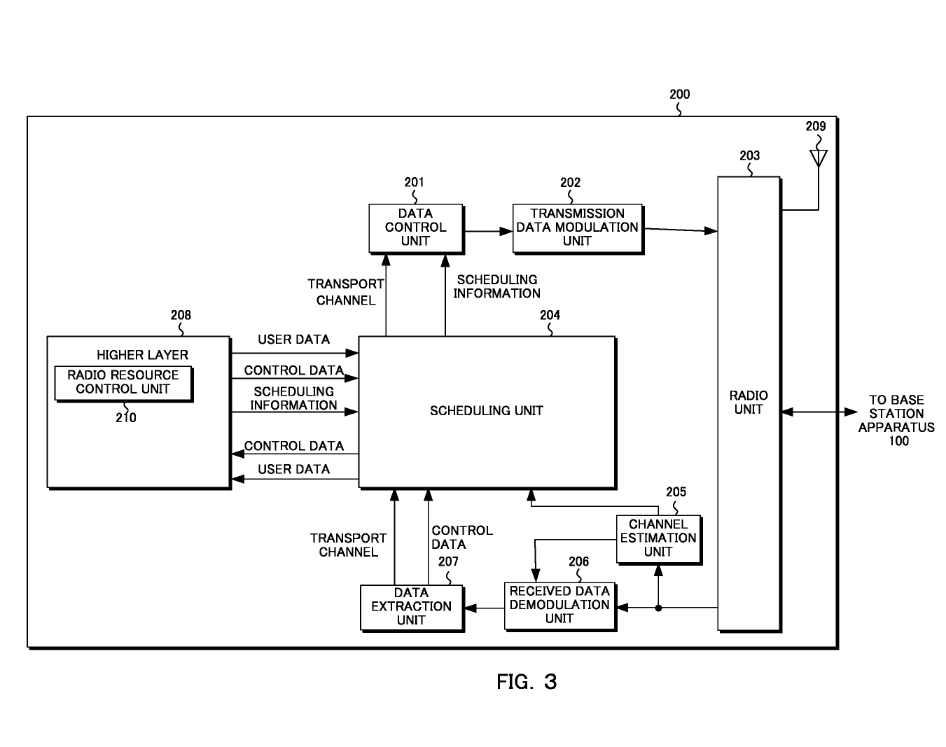

FIG. 3 is a block diagram showing a schematic configuration of the mobile station apparatus 200 pertaining to the embodiment of the present invention. The mobile station apparatus 200 is constituted by including a data control unit 201, a transmission data modulation unit 202, a radio unit 203, a scheduling unit 204, a channel estimation unit 205, a received data demodulation unit 206, a data extraction unit 207, a higher layer 208, and an antenna 209. In addition, a transmission unit is constituted by the data control unit 201, the transmission data modulation unit 202, the radio unit 203, the scheduling unit 204, the higher layer 208, and the antenna 209, and a reception unit is constituted by the radio unit 203, the scheduling unit 204, the channel estimation unit 205, the received data demodulation unit 206, the data extraction unit 207, the higher layer 208, and the antenna 209.

Processing of an uplink physical layer is performed by the data control unit 201, the transmission data modulation unit 202, and the radio unit 203. Processing of a downlink physical layer is performed by the radio unit 203, the channel estimation unit 205, the received data demodulation unit 206, and the data extraction unit 207.

The data control unit 201 receives a transport channel from the scheduling unit 204. The data control unit 201 maps the transport channel, and a signal and a channel that are generated in the physical layer into a physical channel based on scheduling information input from the scheduling unit 204. Each mapped data as described above is output to the transmission data modulation unit 202.

The transmission data modulation unit 202 modulates transmission data to a DFT-Spread-OFDM (SC-FDMA) signal. The transmission data modulation unit 202 performs signal processing such as data modulation, DFT (Discrete Fourier Transform) processing, subcarrier mapping, IFFT (Inverse Fast Fourier Transform) processing, CP insertion, and filtering, on the data input from the data control unit 201, generates transmission data, and outputs it to the radio unit 203.

The radio unit 203 up-converts the modulation data input from the transmission data modulation unit 202 into a radio frequency to thereby generate a radio signal, and transmits it to the base station apparatus 100 via the antenna 209. In addition, the radio unit 203 receives the radio signal modulated by the downlink data from the base station apparatus 100 via the antenna 209, down-converts it into a baseband signal, and outputs the received data to the channel estimation unit 205 and the received data demodulation unit 206.

The scheduling unit 204 performs processing of the MAC (Medium Access Control) layer. The scheduling unit 204 performs mapping of the logical channel and the transport channel, downlink and uplink scheduling (HARQ processing, selection of the transport format, etc.), and the like. In the scheduling unit 204, in order to integrally control a processing unit of each physical layer, there exist the scheduling unit 204, and the antenna 209, the data control unit 201, the transmission data modulation unit 202, the channel estimation unit 205, the received data demodulation unit 206, and an interface between the data extraction unit 207 and the radio unit 203 (however, not shown).

The scheduling unit 204, in the downlink scheduling, performs reception control of the transport channel, a physical signal, and the physical channel, performs HARQ retransmission control, and generates the scheduling information used for downlink scheduling, based on the scheduling information (transport format and HARQ retransmission information) and the like from the base station apparatus 100 and the higher layer 208. The scheduling information used for the downlink scheduling is output to the data control unit 201.

The scheduling unit 204, in the uplink scheduling, performs scheduling processing for mapping the uplink logical channel input from the higher layer 208 into the transport channel and generates the scheduling information used for uplink scheduling, based on an uplink buffer status input from the higher layer 208, uplink scheduling information (the transport format, the HARQ retransmission information, etc.) from the base station apparatus 100 that has been input from the data extraction unit 207, and scheduling information input from the higher layer 208, etc. It should be noted that, as to the uplink transport format, information that the base station apparatus 100 has provided notification of is utilized. The scheduling information is output to the data control unit 201.

In addition, the scheduling unit 204 maps the uplink logical channel input from the higher layer 208 into the transport channel, and outputs it to the data control unit 201. Furthermore, the scheduling unit 204 also outputs, to the data control unit 201, downlink channel state information CSI input from the channel estimation unit 205, the downlink channel quality indicator CQI, the precoding matrix indicator PMI, the rank indicator RI, and the confirmation result of the CRC check input from the data extraction unit 207. Moreover, after processing, as necessary, the control data and the transport channel which have been input from the data extraction unit 207 and which have been obtained in the downlink, the scheduling unit 204 maps them into the downlink logical channel, and outputs them to the higher layer 208.

The channel estimation unit 205, for demodulation of the downlink data, estimates a channel state for downlink demodulation from downlink demodulation reference signals (a DMRS, a mobile station apparatus-specific reference signal, and a Precoded RS), and outputs the estimation result to the received data demodulation unit 206. In addition, in order to notify the base station apparatus 100 of the estimation result of the downlink channel state (feedback the estimation result of the downlink channel state to the base station apparatus 100), the channel estimation unit 205 estimates a channel state for downlink estimation (for feedback) from a downlink estimation reference signal (CSI-RS), and outputs the estimation result to the scheduling unit 204 as the downlink channel state information CSI, the downlink channel quality indicator CQI, the precoding matrix indicator PMI, and the rank indicator RI. Here, the downlink demodulation reference signal is the independent reference signal for each data (layer and rank) spatially multiplexed by the base station, and the mobile station apparatus 200 estimates a channel state for each spatially multiplexed data. In addition, the downlink measurement reference signal is the independent reference signal for each antenna port of the base station, and the mobile station apparatus 200 estimates a channel state of the base station for each antenna port.

The received data demodulation unit 206 demodulates the received data modulated to the OFDM system. The received data demodulation unit 206 performs demodulation processing on the modulation data input from the radio unit 203 based on the estimation result of the downlink channel state input from the channel estimation unit 205, and outputs it to the data extraction unit 207.

The data extraction unit 207 performs CRC check to thereby confirm truth or error of the data input from the received data demodulation unit 206, and also outputs the confirmation result (acknowledgment ACK/non-acknowledgment NACK) to the scheduling unit 204. In addition, the data extraction unit 207 separates the data input from the received data demodulation unit 206 into the transport channel and the physical layer control data, and outputs them to the scheduling unit 204. In the separated control data, scheduling information such as downlink or uplink resource allocation, and uplink HARQ control information is included.

The higher layer 208 performs processing of the PDCP (Packet Data Convergence Protocol) layer, the RLC (Radio Link Control) layer, and the RRC (Radio Resource Control) layer. In the higher layer 208, in order to integrally control processing units of a lower layer, there exist the higher layer 208, the scheduling unit 204, and the antenna 209, the data control unit 201, the transmission data modulation unit 202, the channel estimation unit 205, the received data demodulation unit 206, and the interface between the data extraction unit 207 and the radio unit 203 (however, not shown).

The higher layer 208 has a radio resource control unit 210 (also referred to as a control unit). The radio resource control unit 210 performs management of various setting information, management of system information, paging control, management of a communication state of its own station, mobile management such as handover, management of a buffer status, management of connection setting of unicast and multicast bearers, management of a UEID (mobile station indicator), etc.

### First Embodiment

Next, a first embodiment in a mobile communication system using the base station apparatus 100 and the mobile station apparatus 200 will be described. In the first embodiment, the base station apparatus 100 sets a particular DCC to the mobile station apparatus 200, and when only a PDSCH in the particular DCC is scheduled by the base station apparatus 100, the mobile station apparatus 200 selects a first arrangement method (a mapping method, a multiplexing method, a rearrangement method, or an interleaving method) for UCI, and when at least one PDSCH in DCCs other than the particular DCC is scheduled by the base station apparatus 100, the mobile station apparatus 200 selects a second arrangement method (the mapping method, the multiplexing method, the rearrangement method, or the interleaving method) for the UCI.

That is, the mobile station apparatus 200 switches (selects) the arrangement methods for the UCI in accordance with the scheduling of the PDSCH by the base station apparatus 100. In addition, the base station apparatus 100 receives, from the mobile station apparatus 200, the UCI arranged by the arrangement method switched by the mobile station apparatus 200 in accordance with the scheduling of the PDSCH for the mobile station apparatus 200.

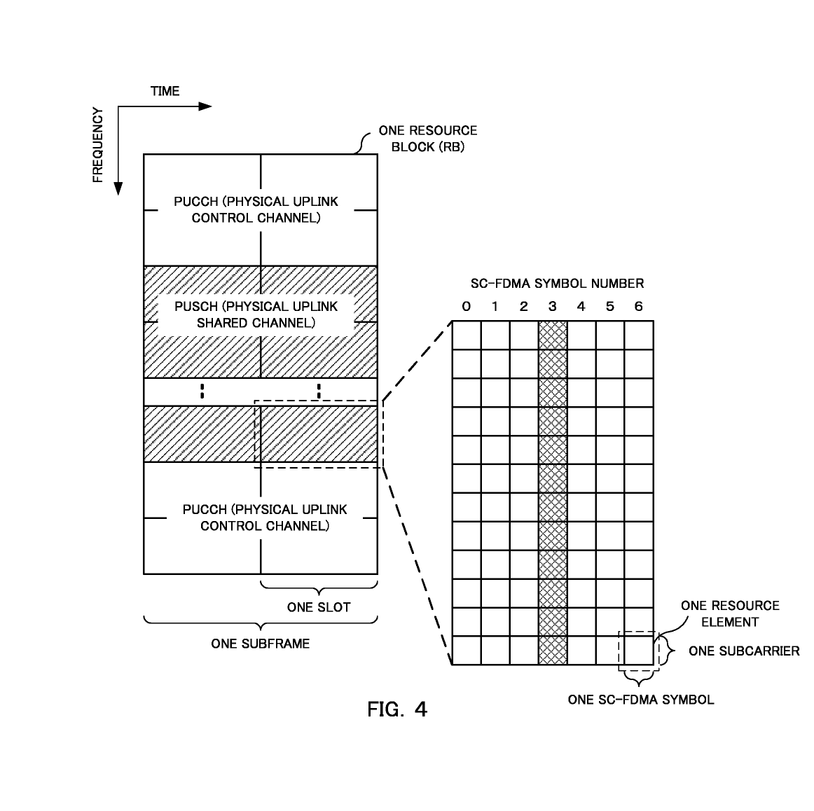

FIG. 4 is a diagram showing a resource configuration in the uplink pertaining to the embodiment. In FIG. 4, a horizontal axis represents time, and a vertical axis represents frequency, respectively.

As shown in FIG. 4, an uplink resource has a PUCCH (physical uplink control channel) mainly utilized to transmit control information, and a PUSCH (physical uplink shared channel) for each mobile station apparatus 200 to mainly transmit data, and each is represented as a set of division units called RBs (resource blocks).

The number of resource blocks in a frequency direction depends on a system bandwidth. In addition, as to a time direction, a time unit occupied by one resource block is called one slot, and two slots are referred to as one subframe. The PUSCH is a resource block unit made of a pair of two slots, and is allocated to the mobile station apparatus 200. Furthermore, in FIG. 4, there is shown a configuration in one resource block of the PUSCH. That is, in FIG. 4, there is shown the enlarged diagram of one resource block of the PUSCH.

For example, one resource block is constituted by seven SC-FDMA symbols (corresponding to one slot) and twelve subcarriers in the frequency direction, and a minimum resource unit constituted by one SC-FDMA symbol and one subcarrier is referred to as an RE (resource element). After a modulation symbol arranged at the RE is converted into a signal of the time domain by processing of FFT (Fast Fourier Transformation) and the like by the SC-FDMA symbol unit, the signal is transmitted to the base station apparatus 100 from the mobile station apparatus 200. In the PUSCH, a DRS for the use of channel estimation at the time of demodulation is arranged at the third SC-FDMA symbol.

Although a frequency band is defined as a bandwidth (Hz) in the embodiment, it may be defined as the number of RBs (resource blocks) constituted by frequency and time. That is, the bandwidth may be defined by the number of RBs. In addition, the bandwidth and the number of RBs can also be defined by the number of subcarriers.

A CC in the embodiment indicates a (narrowband) frequency band complexly used in the base station apparatus 100 and the mobile station apparatus 200 communicating with each other in a mobile communication system having a broadband frequency band (a system band may be substituted). The base station apparatus 100 and the mobile station apparatus 200 constitute a broadband frequency band (for example, the frequency band having the bandwidth of 100 MHz) by aggregating the plurality of CCs (for example, five frequency bands having the bandwidth of 20 MHz), and can achieve high-speed data communication by complexly using these plurality of CCs.

The CC indicates each (narrowband) frequency band (for example, the frequency band having the bandwidth of 20 MHz) that constitutes the broadband frequency band (for example, the frequency band having the bandwidth of 100 MHz). In addition, the CC may indicate a (central) carrier frequency of the each (narrow band) frequency band. That is, the DCC has a part of bands (widths) in frequency bands capable of being used in the base station apparatus 100 and the mobile station apparatus 200 transmitting and receiving downlink information, and the UCC has a part of bands (widths) in frequency bands capable of being used in the base station apparatus 100 and the mobile station apparatus 200 transmitting and receiving uplink information. Furthermore, the CC may be defined as a unit with which a particular physical channel (for example, the PDCCH, the PUCCH, etc.) is constituted.

In addition, the CC may be arranged in contiguous frequency bands, or in non-contiguous frequency bands, the base station apparatus 100 and the mobile station apparatus 200 constitute the broadband frequency band by aggregating the plurality of CCs that is contiguous and/or non-contiguous frequency bands, and high-speed data communication can be achieved by complexly using these plurality of CCs.

Furthermore, the frequency band used for downlink communication and the frequency band used for uplink communication that are constituted by CCs do not need to have a same bandwidth and the base station apparatus 100 and the mobile station apparatus 200 can communicate with each other complexly using the downlink frequency band and the uplink frequency band that are constituted by CCs and that have different bandwidths (the above-mentioned asymmetric carrier aggregation).

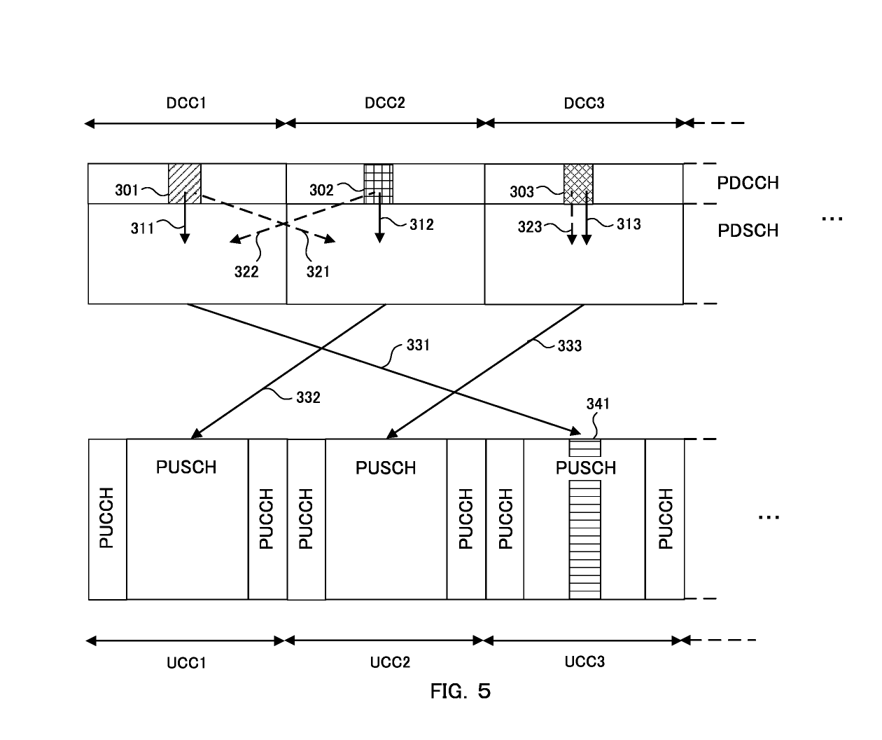

FIG. 5 is a diagram showing an example of a mobile communication system to which the first embodiment can be applied. The first embodiment can be applied to any mobile communication system in which symmetric carrier aggregation and asymmetric carrier aggregation have been performed. In addition, although the following description sets forth only some enlarged CCs as an example, it goes without saying that a similar embodiment can be applied in all the CCs.

FIG. 5 shows three DCCs (DCC1, DCC2, and DCC3) as an example for illustrating the first embodiment. In addition, FIG. 5 shows three UCCs (UCC1, DCC2, and DCC3). In FIG. 5, the base station apparatus 100 can allocate (schedule) (one or more) PDSCHs in a same subframe through the use of (one or more) PDCCHs in the DCC.

Here, the base station apparatus 100 can allocate the PDSCH in a same CC as a CC in which the PDCCH has been arranged. In FIG. 5, it is shown as an example by allocation 311 indicated with a continuous line that the base station apparatus 100 allocates a PDSCH in the DCC1 through the use of a PDCCH301 (PDCCH indicated with an oblique line) in the DCC1. In addition, it is shown by allocation 312 indicated with the continuous line that the base station apparatus 100 allocates a PDSCH in the DCC2 through the use of a PDCCH302 (PDCCH indicated with a grid line) in the DCC2. In addition, it is shown by allocation 313 indicated with the continuous line that the base station apparatus 100 allocates a PDSCH in the DCC3 through the use of a PDCCH303 (PDCCH indicated with a mesh line) in the DCC3.

In addition, the base station apparatus 100 can allocate the PDSCH in the same or different CC as/from the CC in which the PDCCH has been arranged. For example, the base station apparatus 100 can allocate the PDSCH in the same or different CC as/from the CC in which the PDCCH has been arranged by transmitting, to the mobile station apparatus 200, the PDCCH by including therein a CIF (Component carrier Indicator Field, for example, an information field represented with 3 bits).

That is, the base station apparatus 100 transmits the PDCCH by including therein the CIF that instructs a CC in which the PDSCH allocated using the PDCCH is arranged, and can allocate to the mobile station apparatus 200 the PDSCH in the same or different CC as/from the CC in which the PDCCH has been arranged.

Here, it is previously prescribed which PDSCH in the CC the base station apparatus 100 allocates in a case of which value the CIF included in the PDCCH transmitted from the base station apparatus 100 indicates, which is set as known information between the base station apparatus 100 and the mobile station apparatus 200.

For example, the base station apparatus 100 can allocate to the mobile station apparatus 200 the PDSCH in the same CC as the CC in which the PDCCH has been arranged by transmitting, to the mobile station apparatus 200, the PDCCH by including therein a CIF indicating a particular value (for example, the information field represented with 3 bits indicates “000”). In addition, the base station apparatus 100 can allocate to the mobile station apparatus 200 the PDSCH in the CC different from the CC in which the PDCCH has been arranged by transmitting the PDCCH by including therein a CIF indicating a value other than the particular value (for example, the information field represented with 3 bits indicates the value other than “000”).

In FIG. 5, it is shown as an example by allocation 321 indicated with a dotted line that the base station apparatus 100 allocates the PDSCH in the DCC2 through the use of the PDCCH301 (PDCCH indicated with an oblique line) in the DCC1. In addition, it is shown by allocation 322 indicated with the dotted line that the base station apparatus 100 allocates the PDSCH in the DCC1 through the use of the PDCCH302 (PDCCH indicated with a grid line) in the DCC2. In addition, it is shown by allocation 323 indicated with the dotted line that the base station apparatus 100 allocates the PDSCH in the DCC3 through the use of the PDCCH303 (PDCCH indicated with a mesh line) including a CIF in the DCC3.

Furthermore, the base station apparatus 100 can set, for each mobile station apparatus 200, information indicating whether to include the CIF in the PDCCH. For example, the base station apparatus 100 can set to the mobile station apparatus 200 RRC signaling by including therein information indicating whether to include the CIF in the PDCCH. In addition, the base station apparatus 100 can set for each CC information indicating whether to include the CIF in the PDCCH. For example, the base station apparatus 100 can set to the mobile station apparatus 200 for each CC RRC signaling by including therein information indicating whether to include the CIF in the PDCCH.

In FIG. 5, the base station apparatus 100 transmits a downlink transport block to the mobile station apparatus 200 through the use of the PDSCH allocated by the PDCCH, (which can also be said that the base station apparatus 100 transmits the PDSCH). For example, the base station apparatus 100 can transmit (up to three) downlink transport blocks to the mobile station apparatus 200 in the same subframe through the use of the PDSCH allocated by each PDCCH in the DCC1, DCC2, and DCC3.

In addition, in FIG. 5, the base station apparatus 100 can set a particular DCC to the mobile station apparatus 200. For example, the base station apparatus 100 can set the particular DCC to the mobile station apparatus 200 through the use of broadcast information (for example, an SIB (System Information Block)). For example, the base station apparatus 100 can cell-specifically set the particular DCC to the mobile station apparatus 200 through the use of the broadcast information.

In addition, for example, the base station apparatus 100 can set the particular DCC to the mobile station apparatus 200 through the use of the RRC signaling. For example, the base station apparatus 100 can UE-specifically set the particular DCC to the mobile station apparatus 200 through the use of the RRC signaling. In addition, for example, the base station apparatus 100 can semistatically set the particular DCC to the mobile station apparatus 200 through the use of the RRC signaling.

Furthermore, in FIG. 5, the base station apparatus 100 can set correspondence (a link or linking) of the DCC and the UCC to the mobile station apparatus 200. For example, the base station apparatus 100 can set the correspondence of the DCC and the UCC to the mobile station apparatus 200 through the use of the broadcast information (for example, the SIB (System Information Block)) broadcast by each DCC. For example, the base station apparatus 100 can cell-specifically set the correspondence of the DCC and the UCC to the mobile station apparatus 200 through the use of the broadcast information broadcast by each DCC.

In addition, for example, the base station apparatus 100 can set the correspondence of the DCC and the UCC to the mobile station apparatus 200 through the use of the RRC signaling. For example, the base station apparatus 100 can UE200-specifically set the correspondence of the DCC and the UCC to the mobile station apparatus 200 through the use of the RRC signaling. In addition, for example, the base station apparatus 100 can semistatically set the correspondence of the DCC and the UCC to the mobile station apparatus 200 through the use of the RRC signaling.

That is, the base station apparatus 100 sets correspondence of a particular DCC and a particular UCC to the mobile station apparatus 200 through the use of the broadcast information. In addition, the base station apparatus 100 cell-specifically sets the correspondence of the particular DCC and the particular UCC to the mobile station apparatus 200 through the use of the broadcast information.

Furthermore, the base station apparatus 100 sets the correspondence of the particular DCC and the particular UCC to the mobile station apparatus 200 through the use of the RRC signaling. Moreover, the base station apparatus 100 UE200-specifically sets the correspondence of the particular DCC and the particular UCC to the mobile station apparatus 200 through the use of the RRC signaling. In addition, the base station apparatus 100 semistatically sets the correspondence of the particular DCC and the particular UCC to the mobile station apparatus 200 through the use of the RRC signaling.

That is, the base station apparatus 100 can set the particular UCC to the mobile station apparatus 200 as the UCC corresponding to the particular DCC. That is, the base station apparatus 100 sets the particular DCC to the mobile station apparatus 200, and the mobile station apparatus 200 can recognize the UCC corresponding to the particular DCC, as the particular UCC.

For example, in FIG. 5, the base station apparatus 100 can associate the DCC1 and the UCC3 with each other as shown by a link 331. In addition, the base station apparatus 100 can associate the DCC2 and the UCC1 with each other as shown by a link 332. Furthermore, the base station apparatus 100 can associate the DCC3 and the UCC2 with each other as shown by a link 333.

Hereinafter, the particular DCC set by the base station apparatus 100 is also referred to as a PDCC (Primary Downlink Component Carrier). In addition, a DCC other than the particular DCC set by the base station apparatus 100 is also referred to as an SDCC (Secondary Downlink Component Carrier).

Furthermore, the particular UCC recognized by the mobile station apparatus 200 as the UCC corresponding to the particular DCC is also referred to as a PUCC (Primary Uplink Component Carrier). Furthermore, a UCC other than the particular UCC is also referred to as an SUCC (Secondary Uplink Component Carrier).

For example, in FIG. 5, when the base station apparatus 100 sets the DCC1 as the PDCC to the mobile station apparatus 200, the mobile station apparatus 200 recognizes the UCC3 as the PUCC, and recognizes the UCC1 and the UCC2 as the SUCCs. In addition, when the base station apparatus 100 sets the DCC2 as the PDCC to the mobile station apparatus 200, the mobile station apparatus 200 recognizes the UCC1 as the PUCC, and recognizes the UCC2 and the UCC3 as the SUCCs. Furthermore, when the base station apparatus 100 sets the DCC3 as the PDCC to the mobile station apparatus 200, the mobile station apparatus 200 recognizes the UCC2 as the PUCC, and recognizes the UCC1 and the UCC3 as the SUCCs.

In the following example, for the sake of ease, there will be described a case where the base station apparatus 100 set, to the mobile station apparatus 200, the DCC2 as the PDCC, and the UCC1 corresponding to the DCC2 as the PUCC.

In FIG. 5, the mobile station apparatus 200 transmits an uplink transport block (UL-SCH) to the base station apparatus 100 through the use of the PUSCH allocated (scheduled) by the PDCCH (it is also said to be an uplink transmission permission signal) transmitted from the base station apparatus 100. That is, the mobile station apparatus 200 arranges the uplink transport block (UL-SCH) in an allocated resource in accordance with resource allocation information for the PUSCH included in the PDCCH transmitted from the base station apparatus 100, and transmits the uplink transport block to the base station apparatus 100. For example, the mobile station apparatus 200 can transmit (a maximum of three) uplink transport blocks (UL-SCHs) to the base station apparatus 100 in the same subframe through the use of the PUSCHs in the UCC1, UCC2, and UCC3.

In addition, the mobile station apparatus 200 transmits UCI to the base station apparatus 100 through the use of the PUCCH. That is, the mobile station apparatus 200 transmits the UCI to the base station apparatus 100 through the use of the PUCCH in the UCC1 (PUCC) corresponding to the DCC2 set as the PDCC by the base station apparatus 100.

Furthermore, when the PUSCH is allocated (scheduled) by the base station apparatus 100, the mobile station apparatus 200 arranges the UCI in the PUSCH to transmit to the base station apparatus 100. For example, when the PUSCH in the UCC1 is scheduled by the base station apparatus 100, the mobile station apparatus 200 arranges the UCI in the PUSCH in the UCC1 to transmit to the base station apparatus 100. Similarly, when the PUSCH in the UCC2 is scheduled by the base station apparatus 100, the mobile station apparatus 200 arranges the UCI in the PUSCH in the UCC2 to transmit to the base station apparatus 100. Similarly, when the PUSCH in the UCC3 is scheduled by the base station apparatus 100, the mobile station apparatus 200 arranges the UCI in the PUSCH in the UCC3 to transmit to the base station apparatus 100.

FIG. 5 shows that the base station apparatus 100 schedules a PUSCH341 in the UCC3 for the mobile station apparatus 200, and that the mobile station apparatus 200 arranges the UCI in the PUSCH341 in the UCC3 to transmit to the base station apparatus 100.

Here, when the plurality of PUSCHs is scheduled in the same subframe by the base station apparatus 100, the mobile station apparatus 200 arranges the UCI in any of the plurality of PUSCHs to transmit to the base station apparatus 100. For example, when the plurality of PUSCHs is scheduled in the same subframe by the base station apparatus 100, the mobile station apparatus 200 can arrange the UCI in the PUSCH in the PUCC to transmit to the base station apparatus 100. For example, when the PUSCHs in the UCC1, UCC2, and UCC3 are scheduled in the same subframe by the base station apparatus 100, the mobile station apparatus 200 can arrange the UCI in the PUSCH in the UCC1 to transmit to the base station apparatus 100.

In addition, in arranging the UCI in the PUSCH to transmit to the base station apparatus 100, the mobile station apparatus 200 can arrange the UCI and the UL-SCH together in the PUSCH to transmit to the base station apparatus 100.

For example, the mobile station apparatus 200 can arrange control information in a HARQ and the UL-SCH together in the PUSCH scheduled by the base station apparatus 100, to transmit to the base station apparatus 100. That is, the mobile station apparatus 200 can arrange together, in the PUSCH scheduled by the base station apparatus 100, information indicating an ACK/NACK of the plurality of downlink transport blocks (PDSCHs may be substituted) transmitted in the same subframe through the use of the plurality of DCCs, and the UL-SCH, to transmit to the base station apparatus 100.

In addition, for example, the mobile station apparatus 200 arranges feedback information and the UL-SCH together in the PUSCH scheduled by the base station apparatus 100 to transmit to the base station apparatus 100. For example, the mobile station apparatus 200 can arrange all or a part of the RI, the CQI, and the PMI, and the UL-SCH together in the PUSCH scheduled by the base station apparatus 100 to transmit to the base station apparatus 100.

Here, the mobile station apparatus 200 can switch (select) the arrangement methods for the UCI in accordance with the scheduling of the PDSCH by the base station apparatus 100.

Here, the arrangement method of the UCI by the mobile station apparatus 200 indicates the arrangement method in the mobile station apparatus 200 arranging the UCI at an SC-FDMA symbol. That is, when the PUSCH is scheduled by the base station apparatus 100, the mobile station apparatus 200 arranges the UCI at the SC-FDMA symbol, applies DFT processing for each SC-FDMA symbol, converts it into a signal of the frequency domain and subsequently, arranges it in the PUSCH scheduled by the base station apparatus 100.

Furthermore, IFFT processing is applied to the PUSCH according to the number of FFT points (for example, 2048), the PUSCH is converted into a signal of the time domain, subsequently, a cyclic prefix (guard interval) is added to the signal for each SC-FDMA symbol, and the signal is transmitted to the base station apparatus 100 as the SC-FDMA signal.

More specifically, the mobile station apparatus 200 defines a matrix of a size equal to a size of the PUSCH (a PUSCH resource constituted by the time domain and the frequency domain) scheduled by the base station apparatus 100, and arranges the UCI in the defined matrix.

After applying the DFT processing to this matrix, and converting it into a signal of the frequency domain, the mobile station apparatus 200 arranges the information after DFT in the PUSCH scheduled by the base station apparatus 100. The arrangement method of the UCI by the mobile station apparatus 200 indicates the method in the mobile station apparatus 200 arranging the UCI in the defined matrix.

Here, details of the arrangement methods switched by the mobile station apparatus 200 in accordance with the scheduling of the PDSCH by the base station apparatus 100 will be mentioned later. Hereinafter, the arrangement methods switched by the mobile station apparatus 200 will be also set forth as a first arrangement method and a second arrangement method.

Here, arrangement of the UCI is the arrangement of signals before the DFT processing is applied thereto, and also includes a case where multiprocessing and rearrangement processing (interleaving processing) are performed, and the signals are arranged as a result of the processing. For example, multiprocessing of the CQI and/or the PMI, and the UL-SCH can also be included in arrangement processing (the arrangement method). In addition, rearrangement processing of the RI, the control information in the HARQ, and the UL-SCH can also be included in the arrangement processing (arrangement method).

In FIG. 5, the mobile station apparatus 200 switches the arrangement methods for the UCI in accordance with the scheduling of the PDSCH by the base station apparatus 100.

When the PUSCH is scheduled by the base station apparatus 100 in transmitting the control information in the HARQ to the PDSCH (downlink transport block may be substituted) transmitted by the base station apparatus 100, the mobile station apparatus 200 arranges the control information in the HARQ in the PUSCH to transmit to the base station apparatus 100.

In addition, the mobile station apparatus 200 can arrange the control information in the HARQ and the UL-SCH together in the PUSCH scheduled by the base station apparatus 100 to transmit to the base station apparatus 100. In addition, the mobile station apparatus 200 can arrange the control information in the HARQ and the feedback information together in the PUSCH scheduled by the base station apparatus 100 to transmit to the base station apparatus 100. That is, the mobile station apparatus 200 can arrange the control information in the HARQ, the feedback information, and the UL-SCH together in the PUSCH scheduled by the base station apparatus 100 to transmit to the base station apparatus 100.

Here, when the PDSCH in the DCC set as the PDCC by the base station apparatus 100 is scheduled, the mobile station apparatus 200 arranges the UCI through the use of the first arrangement method. That is, when only the PDSCH in the DCC set as the PDCC by the base station apparatus 100 is scheduled, the mobile station apparatus 200 arranges the UCI through the use of the first arrangement method.

That is, as will be mentioned later, when the plurality of PDSCHs including the PDSCH in the DCC set as the PDCC by the base station apparatus 100 is scheduled, the mobile station apparatus 200 arranges the UCI through the use of the second arrangement method.

For example, in FIG. 5, when only the PDSCH in the DCC2 set as the PDCC by the base station apparatus 100 is scheduled, the mobile station apparatus 200 arranges the UCI through the use of the first arrangement method. For example, when the PDSCH in the DCC2 is scheduled by the base station apparatus 100 through the use of the PDCCH in the DCC2, the mobile station apparatus 200 arranges the UCI through the use of the first arrangement method. That is, when the base station apparatus 100 schedules the PDSCH through the use of the PDCCH in the PDCC, the mobile station apparatus 200 arranges the UCI through the use of the first arrangement method.

In addition, for example, when the PDSCH in the DCC2 is scheduled by the base station apparatus 100 through the use of the PDCCH in the DCC1 or the DCC3, the mobile station apparatus 200 arranges the UCI through the use of the first arrangement method. That is, when the base station apparatus 100 schedules the PDSCH in the PDCC through the use of the PDCCH in the SDCC, the mobile station apparatus 200 arranges the UCI through the use of the first arrangement method.

In FIG. 5, when the PDSCH in the DCC set as the PDCC by the base station apparatus 100 is scheduled, the mobile station apparatus 200 arranges the UCI through the use of the first arrangement method, and can transmit it to the base station apparatus 100 through the use of the PUSCH scheduled by the base station apparatus 100.

That is, the mobile station apparatus 200 transmits, to the base station apparatus 100, the control information in the HARQ for the PDSCH in the DCC set as the PDCC by the base station apparatus 100 (control information in the HARQ for the downlink transport block transmitted through the use of the PDSCH may be substituted) through the use of the PUSCH scheduled by the base station apparatus 100. Hereinafter, the control information in the HARQ for the PDSCH in the DCC set as the PDCC by the base station apparatus 100 is also referred to as control information in a first HARQ.

In FIG. 5, the mobile station apparatus 200 can transmit the control information in the first HARQ and the UL-SCH together to the base station apparatus 100 through the use of the PUSCH scheduled by the base station apparatus 100. In addition, the mobile station apparatus 200 can transmit the control information in the first HARQ and the feedback information together to the base station apparatus 100 through the use of the PUSCH scheduled by the base station apparatus 100. That is, the mobile station apparatus 200 arranges the control information in the first HARQ, the feedback information, and the UL-SCH together in the PUSCH scheduled by the base station apparatus 100 to transmit to the base station apparatus 100.

In addition, in FIG. 5, when a PDSCH in a DCC other than the DCC set as the PDCC by the base station apparatus 100 is scheduled, the mobile station apparatus 200 arranges the UCI through the use of the second arrangement method. That is, when the PDSCH in the DCC set as the SDCC by the base station apparatus 100 is scheduled, the mobile station apparatus 200 arranges the UCI through the use of the second arrangement method.

Furthermore, in FIG. 5, when the plurality of PDSCHs is scheduled, the mobile station apparatus 200 arranges the UCI through the use of the second arrangement method. That is, when the plurality of PDSCHs including the PDSCH in the DCC set as the PDCC by the base station apparatus 100 is scheduled, the mobile station apparatus 200 arranges the UCI through the use of the second arrangement method. That is, when at least one PDSCH in the DCC set as the SDCC by the base station apparatus 100 is scheduled, the mobile station apparatus 200 arranges the UCI through the use of the second arrangement method.

For example, in FIG. 5, when the PDSCH in the DCC1 and/or the DCC3 set as the SDCC by the base station apparatus 100 is scheduled, the mobile station apparatus 200 arranges the UCI through the use of the second arrangement method. For example, when the PDSCH in the DCC1 and/or the DCC3 is scheduled by the base station apparatus 100 through the use of the PDCCH in the DCC1 and/or the DCC3, the mobile station apparatus 200 arranges the UCI through the use of the second arrangement method. That is, when the base station apparatus 100 schedules the PDSCH through the use of the PDCCH in the SDCC, the mobile station apparatus 200 arranges the UCI through the use of the second arrangement method.

In addition, for example, when the PDSCH in the DCC1 and/or the DCC3 is scheduled through the use of the PDCCH in the DCC2 set as the PDCC by the base station apparatus 100, the mobile station apparatus 200 maps the UCI through the use of the second arrangement method. That is, when the base station apparatus 100 schedules the PDSCH in the SDCC through the use of the PDCCH in the PDCC, the mobile station apparatus 200 arranges the UCI through the use of the second arrangement method.

In FIG. 5, when at least one PDSCH in the DCC set as the SDCC by the base station apparatus 100 is scheduled, the mobile station apparatus 200 arranges the UCI through the use of the second arrangement method, and can transmit it to the base station apparatus 100 through the use of the PUSCH scheduled by the base station apparatus 100.

That is, the mobile station apparatus 200 transmits, to the base station apparatus 100, the control information in the HARQ for the PDSCH in the DCC set as the SDCC by the base station apparatus 100 (control information in the HARQ for the downlink transport block transmitted using the PDSCH may be substituted) through the use of the PUSCH scheduled by the base station apparatus 100. That is, the mobile station apparatus 200 transmits, to the base station apparatus 100, control information in the HARQ for the plurality of PDSCHs in the plurality of DCCs set as the SDCC by the base station apparatus 100 (the plurality of PDSCHs transmitted in the same subframe in the SDCC) through the use of the PUSCH scheduled by the base station apparatus 100.

In addition, the mobile station apparatus 200 transmits, to the base station apparatus 100, control information in the HARQ for the plurality of PDSCHs in the plurality of DCCs set as the PDCC and the SDCC by the base station apparatus 100 (the plurality of PDSCHs transmitted in the same subframe in the PDCC and the SDCC), through the use of the PUSCH scheduled by the base station apparatus 100.

Hereinafter, the control information in the HARQ for the PDSCH in the DCC set as the SDCC by the base station apparatus 100 is also referred to as control information in a second HARQ. Similarly, the control information in the HARQ for the plurality of PDSCHs in the plurality of DCCs set as the SDCC by the base station apparatus 100 is also referred to as the control information in the second HARQ. In the same way, the control information in the HARQ for the plurality of PDSCHs in the plurality of DCCs set as the PDCC and the SDCC by the base station apparatus 100 is also referred to as the control information in the second HARQ.

Here, as mentioned above, the control information in the HARQ for the PDSCH transmitted in the PDCC can be included in the control information in the second HARQ. In addition, the control information in the HARQ for the PDSCH transmitted in the SDCC can be included in the control information in the second HARQ. In addition, the control information in the HARQ for the plurality of PDSCHs transmitted in the same subframe by the base station apparatus 100 through the use of the plurality of DCCs can be included in the control information in the second HARQ.

In FIG. 5, the mobile station apparatus 200 can transmit the control information in the second HARQ and the UL-SCH together to the base station apparatus 100 through the use of the PUSCH scheduled by the base station apparatus 100. In addition, the mobile station apparatus 200 can transmit the control information in the second HARQ and the feedback information together to the base station apparatus 100 through the use of the PUSCH scheduled by the base station apparatus 100. That is, the mobile station apparatus 200 arranges the control information in the second HARQ, the feedback information, and the UL-SCH together in the PUSCH scheduled by the base station apparatus 100, to transmit to the base station apparatus 100.

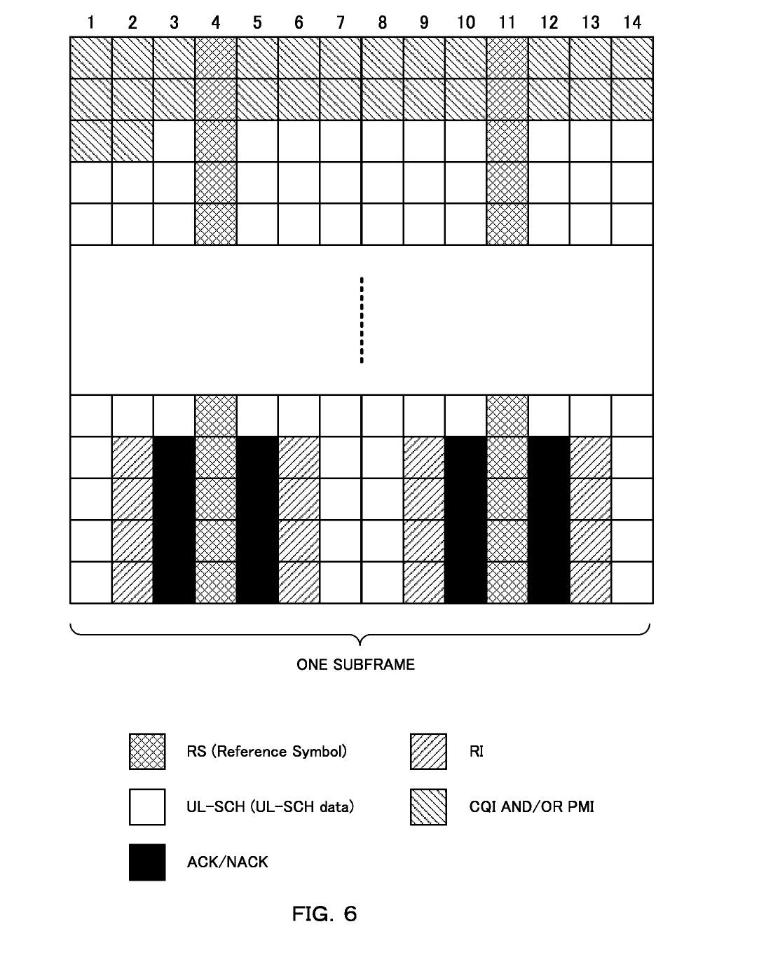

FIG. 6 is a diagram illustrating the first arrangement method and the second arrangement method for the UCI by the mobile station apparatus 200. As mentioned above, FIG. 6 shows an appearance in which signals (information) before DFT processing is applied are arranged. FIG. 6 shows an arrangement example in a case where in the mobile station apparatus 200, UL-SCHs (painted white), CQIs and/or PMIs (shown with a rising oblique line from bottom left to top right), RIs (shown with a rising oblique line from bottom right to top left), and control information in a HARQ (painted black, and it indicates information indicating an ACK/NACK in FIG. 6) are scheduled in a same subframe. In addition, reference signals (shown in a mesh line) are also shown in FIG. 6.

In FIG. 6, a horizontal axis represents time, and indicates fourteen SC-FDMA symbols (one subframe). In addition, a vertical axis does not correspond to a frequency axis, but indicates an alignment of modulation symbol groupings in the UCI being arranged. Here, the vertical axis corresponds to a frequency domain of a PUSCH resource scheduled by the base station apparatus 100. DFT processing of each SC-FDMA symbol is performed for each SC-FDMA symbol, and it is arranged in the PUSCH resource allocated on the frequency axis.

In FIG. 6, first, the mobile station apparatus 200 performs multiprocessing of the CQI and/or the PMI, and the UL-SCH. That is, the mobile station apparatus 200 performs multiprocessing of the CQI and/or the PMI, and the UL-SCH, and generates the CQI and/or the PMI, and the UL-SCH which have been multiplexed. In the multiprocessing, the mobile station apparatus 200 multiplexes the CQI and/or the PMI, and the UL-SCH so that they are arranged by the arrangement method as shown in FIG. 6.

Subsequently, the mobile station apparatus 200 performs rearrangement processing (interleaving processing) of the CQI and/or the PMI, the UL-SCH, the RI, and the information indicating the ACK/NACK which have been multiplexed. In the rearrangement processing, the mobile station apparatus 200 first prepares a matrix as shown in FIG. 6. It should be noted that the uplink demodulation reference signal is always arranged at the fourth and eleventh SC-FDMA symbols.

The mobile station apparatus 200 arranges the RI in the matrix through the use of the arrangement method as shown in FIG. 6. That is, the RI is arranged at the second, sixth, ninth, and thirteenth SC-FDMA symbols (i.e., at the −second and +second SC-FDMA symbols of the SC-FDMA symbol at which each reference signal is arranged).

Furthermore, the mobile station apparatus 200 first arranges the CQI and/or the PMI, and the UL-SCH which have been multiplexed in the matrix in a horizontal axis direction (time direction), arranges them at all the SC-FDMA symbols in the horizontal axis direction (all the SC-FDMA symbols excluding the reference signals) and subsequently, arranges them in a vertical axis direction (referred to as time first mapping). At that time, the mobile station apparatus 200 skips an element of the matrix in which the RI has been arranged, and arranges the CQI and/or the PMI, and the UL-SCH which have been multiplexed.

Moreover, the mobile station apparatus 200 overwrites (also referred to as punctures) a part of the CQI and/or the PMI, and the UL-SCH which have been multiplexed with the information indicating the ACK/NACK so that it is arranged by the arrangement method as shown in FIG. 6.

That is, the part of the CQI and/or the PMI, and the UL-SCH which have been multiplexed is overwritten with the information indicating the ACK/NACK so that it is arranged at the third, fifth, tenth, and twelfth SC-FDMA symbols (i.e., at the −first and +first SC-FDMA symbols of the SC-FDMA symbol at which each reference signal is arranged).

That is, when the mobile station apparatus 200 arranges the information indicating the ACK/NACK, some elements of the CQI and/or the PMI, and the UL-SCH which have been multiplexed in the already occupied matrix are overwritten. In addition, such overwrite processing is also referred to as rearrangement processing.

The mobile station apparatus 200 arranges, in the elements of the matrix, the CQI and/or PMI, the UL-SCH, the RI, and the information indicating the ACK/NACK to which multiprocessing and rearrangement processing have been applied, and thus each UCI is arranged as shown in FIG. 6. Here, multiprocessing and rearrangement processing are also referred to as arrangement processing (mapping processing).

When only the PDSCH in the PDCC is scheduled by the base station apparatus 100, the mobile station apparatus 200 arranges the UCI through the use of the first arrangement method as shown in FIG. 6. That is, the mobile station apparatus 200 transmits the UCI arranged through the use of the first arrangement method as shown in FIG. 6 to the base station apparatus 100 through the use of the PUSCH scheduled by the base station apparatus 100.

The base station apparatus 100 receives the UCI arranged by the first arrangement method by the mobile station apparatus 200. For example, the base station apparatus 100 extracts, from the PUSCH, the UCI arranged by the first arrangement method, and performs scheduling to the mobile station apparatus 200 based on the extracted UCI.

Here, the second arrangement method for the UCI by the mobile station apparatus 200 will be described using FIG. 6.

In FIG. 6, first, the mobile station apparatus 200 performs multiprocessing of the CQI and/or the PMI, and the UL-SCH. That is, the mobile station apparatus 200 performs multiprocessing of the CQI and/or the PMI, and the UL-SCH, and generates the CQI and/or the PMI, and the UL-SCH which have been multiplexed. In the multiprocessing, the mobile station apparatus 200 multiplexes the CQI and/or the PMI, and the UL-SCH so that they are arranged by the arrangement method as shown in FIG. 6.

Subsequently, the mobile station apparatus 200 performs rearrangement processing (interleaving processing) of the CQI and/or the PMI, the UL-SCH, the RI, and the information indicating the ACK/NACK which have been multiplexed. In the rearrangement processing, the mobile station apparatus 200 first prepares a matrix as shown in FIG. 6. It should be noted that the uplink demodulation reference signal is always arranged at the fourth and eleventh SC-FDMA symbols.

The mobile station apparatus 200 arranges the RI and the information indicating the ACK/NACK in the matrix through the use of the arrangement method as shown in FIG. 6. That is, the RI is arranged at the second, sixth, ninth, and thirteenth SC-FDMA symbols (i.e., at the −second and +second SC-FDMA symbols of the SC-FDMA symbol at which each reference signal is arranged). In addition, the information indicating the ACK/NACK is arranged at the third, fifth, tenth, and twelfth SC-FDMA symbols (i.e., at the −first and +first SC-FDMA symbols of the SC-FDMA symbol at which each reference signal is arranged).

Furthermore, the mobile station apparatus 200 arranges the CQI and/or the PMI, and the UL-SCH which have been multiplexed in the matrix, first, in the horizontal axis direction (time direction), arranges them at all the SC-FDMA symbols in the horizontal axis direction (all the SC-FDMA symbols excluding the reference signals) and subsequently, arranges them in the vertical axis direction (referred to as time first mapping). At that time, the mobile station apparatus 200 skips an element of the matrix in which the RI and the information indicating the ACK/NACK have been arranged, and arranges the CQI and/or the PMI, and the UL-SCH which have been multiplexed.

The mobile station apparatus 200 arranges in the elements of the matrix the CQI and/or PMI, the UL-SCH, the RI, and the information indicating the ACK/NACK to which multiprocessing and rearrangement processing have been applied, and thus each UCI is arranged as shown in FIG. 6. Here, multiprocessing and rearrangement processing are also referred to as arrangement processing (mapping processing).

When at least one PDSCH in the SDCC is scheduled by the base station apparatus 100, the mobile station apparatus 200 arranges the UCI through the use of the second arrangement method as shown in FIG. 6. That is, the mobile station apparatus 200 transmits the UCI arranged through the use of the second arrangement method as shown in FIG. 6 to the base station apparatus 100 through the use of the PUSCH scheduled by the base station apparatus 100.

The mobile station apparatus 200 arranges the UCI through the use of the second arrangement method shown in FIG. 6 as mentioned above, and thus can be eliminated the UCI (CQI and/or PMI, and UL-SCH) to be overwritten (punctured) in arranging control information in the HARQ (information indicating the ACK/NACK).

The base station apparatus 100 receives the UCI arranged by the second arrangement method by the mobile station apparatus 200. For example, the base station apparatus 100 extracts from the PUSCH the UCI arranged by the second arrangement method, and performs scheduling to the mobile station apparatus 200 based on the extracted UCI.

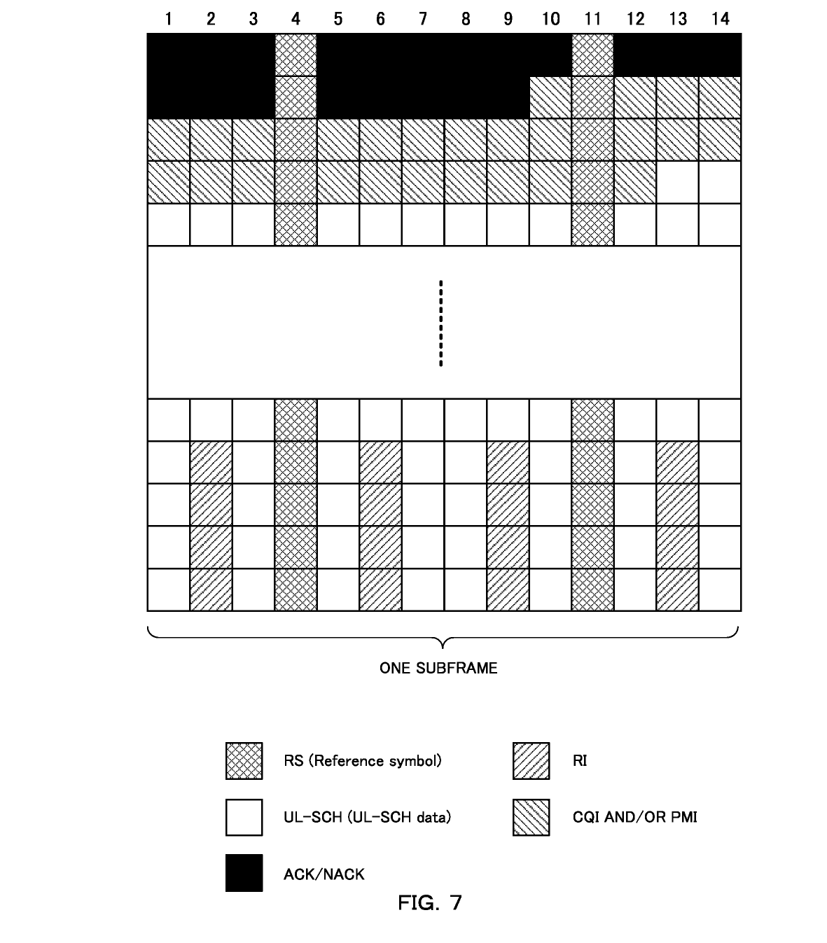

FIG. 7 is a diagram illustrating the second arrangement method for the UCI by the mobile station apparatus 200. FIG. 7 is a drawing similar to FIG. 6.

In FIG. 7, first, the mobile station apparatus 200 performs multiprocessing of the information indicating the ACK/NACK, the CQI and/or the PMI, and the UL-SCH. That is, the mobile station apparatus 200 performs multiprocessing of the information indicating the ACK/NACK, the CQI and/or the PMI, and the UL-SCH, and generates the information indicating the ACK/NACK, the CQI and/or the PMI, and the UL-SCH which have been multiplexed. In the multiprocessing, the mobile station apparatus 200 multiplexes the information indicating the ACK/NACK, the CQI and/or the PMI, and the UL-SCH so that they are arranged by the arrangement method as shown in FIG. 7.

Subsequently, the mobile station apparatus 200 performs rearrangement processing (interleaving processing) of the information indicating the ACK/NACK, the CQI and/or the PMI, the UL-SCH, and the RI which have been multiplexed. In the rearrangement processing, the mobile station apparatus 200 first prepares a matrix as shown in FIG. 7. It should be noted that the uplink demodulation reference signal is always arranged at the fourth and eleventh SC-FDMA symbols.

The mobile station apparatus 200 arranges the RI in the matrix through the use of the arrangement method as shown in FIG. 7. That is, the RI is arranged at the second, sixth, ninth, and thirteenth SC-FDMA symbols (i.e., at the −second and +second SC-FDMA symbols of the SC-FDMA symbol at which each reference signal is arranged).

Furthermore, the mobile station apparatus 200 arranges the information indicating the ACK/NACK, the CQI and/or the PMI, and the UL-SCH which have been multiplexed in the matrix, first, in the horizontal axis direction (time direction), and arranges them at all the SC-FDMA symbols in the horizontal axis direction (all the SC-FDMA symbols excluding the reference signals) and subsequently, arranges them in the vertical axis direction (referred to as time first mapping). At that time, the mobile station apparatus 200 skips the element of the matrix in which the RI has been arranged, and arranges the information indicating the ACK/NACK, the CQI and/or the PMI, and the UL-SCH which have been multiplexed.

The mobile station apparatus 200 arranges in the elements of the matrix the CQI and/or PMI, the UL-SCH, the RI, and the information indicating the ACK/NACK to which multiprocessing and rearrangement processing have been applied, and thus each UCI is arranged as shown in FIG. 7. Here, multiprocessing and rearrangement processing are also referred to as arrangement processing (mapping processing).

Furthermore, the second arrangement method for the UCI by the mobile station apparatus 200 will be described using FIG. 7.

In FIG. 7, first, the mobile station apparatus 200 performs multiprocessing of the CQI and/or the PMI, and the UL-SCH. That is, the mobile station apparatus 200 performs multiprocessing of the CQI and/or the PMI, and the UL-SCH, and generates the CQI and/or the PMI, and the UL-SCH which have been multiplexed. In the multiprocessing, the mobile station apparatus 200 multiplexes the CQI and/or the PMI, and the UL-SCH so that they are arranged by the arrangement method as shown in FIG. 7.

Subsequently, the mobile station apparatus 200 performs rearrangement processing (interleaving processing) of the CQI and/or the PMI, the UL-SCH, the RI, and the information indicating the ACK/NACK which have been multiplexed. In the rearrangement processing, the mobile station apparatus 200 first prepares a matrix as shown in FIG. 7. It should be noted that the uplink demodulation reference signal is always arranged at the fourth and eleventh SC-FDMA symbols.

The mobile station apparatus 200 arranges the information indicating the ACK/NACK in the matrix through the use of the arrangement method as shown in FIG. 7. That is, the mobile station apparatus 200 arranges the information indicating the ACK/NACK in the matrix, first, in the horizontal axis direction (time direction), arranges them at all the SC-FDMA symbols in the horizontal axis direction (all the SC-FDMA symbols excluding the reference signals) and subsequently, arranges them in the vertical axis direction (referred to as time first mapping).

Furthermore, the mobile station apparatus 200 arranges the RI in the matrix through the use of the arrangement method as shown in FIG. 7. That is, the RI is arranged at the second, sixth, ninth, and thirteenth SC-FDMA symbols (i.e., at the −second and +second SC-FDMA symbols of the SC-FDMA symbol at which each reference signal is arranged).

Moreover, the mobile station apparatus 200 arranges the CQI and/or the PMI, and the UL-SCH which have been multiplexed in the matrix, first, in the horizontal axis direction (time direction), arranges them at all the SC-FDMA symbols in the horizontal axis direction (all the SC-FDMA symbols excluding the reference signals) and subsequently, arranges them in the vertical axis direction (referred to as time first mapping). At that time, the mobile station apparatus 200 skips elements of the matrix in which the information indicating the ACK/NACK and the RI have been arranged, and arranges the CQI and/or the PMI, and the UL-SCH which have been multiplexed.

The mobile station apparatus 200 arranges in the elements of the matrix the CQI and/or PMI, the UL-SCH, the RI, and the information indicating the ACK/NACK to which multiprocessing and rearrangement processing have been applied, and thus each UCI is arranged as shown in FIG. 7. Here, multiprocessing and rearrangement processing are also referred to as arrangement processing (mapping processing).

When at least one PDSCH in the SDCC is scheduled by the base station apparatus 100, the mobile station apparatus 200 arranges the UCI through the use of the second arrangement method as shown in FIG. 7. That is, the mobile station apparatus 200 transmits the UCI arranged through the use of the second arrangement method as shown in FIG. 7 to the base station apparatus 100 through the use of the PUSCH scheduled by the base station apparatus 100.

The mobile station apparatus 200 arranges the UCI through the use of the second arrangement method shown in FIG. 7, and thus can be eliminated the UCI (CQI and/or PMI, and UL-SCH) to be overwritten (punctured) in arranging control information in the HARQ (information indicating the ACK/NACK). Here, in FIG. 7, the RI may be rearranged at the third and fifth SC-FDMA symbols (i.e., at the −first and +first SC-FDMA symbols of the SC-FDMA symbol at which each reference signal is arranged).

The base station apparatus 100 receives the UCI arranged by the second arrangement method by the mobile station apparatus 200. For example, the base station apparatus 100 extracts from the PUSCH the UCI arranged by the second arrangement method, and performs scheduling to the mobile station apparatus 200 based on the extracted UCI.

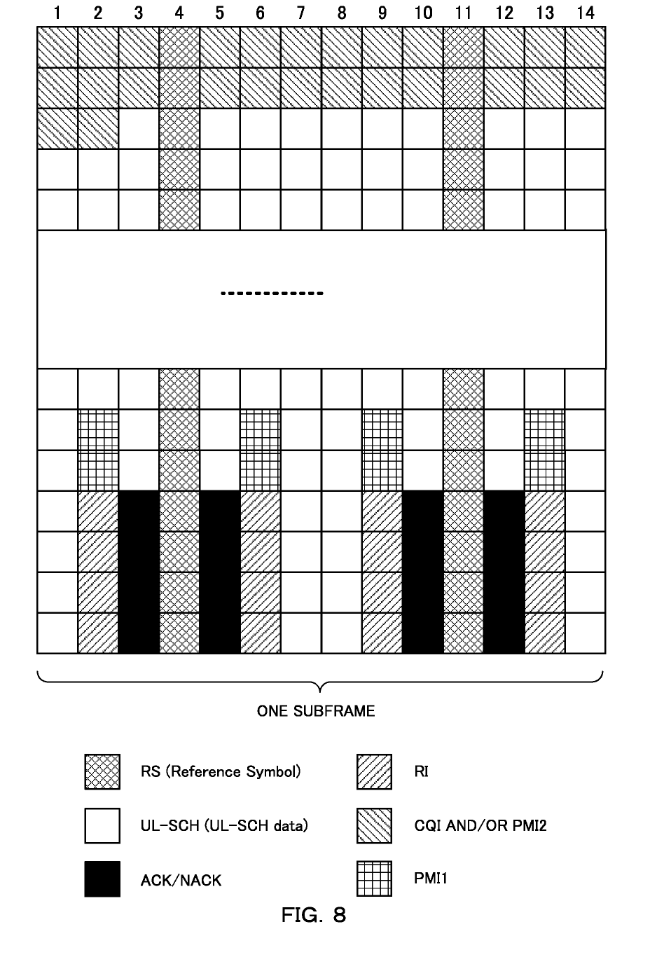

FIG. 8 is a diagram illustrating a second mapping method for the UCI by the mobile station apparatus 200. FIG. 8 is the drawing similar to FIGS. 6 and 7. In FIG. 8, a case will be described where the PMI is separated into the PMI1 and the PMI2 as already described.

In FIG. 8, first, the mobile station apparatus 200 performs multiprocessing of the CQI and/or the PMI2, and the UL-SCH. That is, the mobile station apparatus 200 performs multiprocessing of the CQI and/or the PMI2, and the UL-SCH, and generates the CQI and/or the PMI2, and the UL-SCH which have been multiplexed. In the multiprocessing, the mobile station apparatus 200 multiplexes the CQI and/or the PMI2, and the UL-SCH so that they are arranged by the arrangement method as shown in FIG. 8.

Subsequently, the mobile station apparatus 200 performs rearrangement processing (interleaving processing) of the CQI and/or the PMI2, the UL-SCH, the RI, the PMI1, and the information indicating the ACK/NACK which have been multiplexed. In the rearrangement processing, the mobile station apparatus 200 first prepares a matrix as shown in FIG. 8. It should be noted that the uplink demodulation reference signal is always arranged at the fourth and eleventh SC-FDMA symbols.

The mobile station apparatus 200 arranges the RI and the PMI1 in the matrix through the use of the arrangement method as shown in FIG. 8. That is, the RI and the PMI1 are arranged at the second, sixth, ninth, and thirteenth SC-FDMA symbols (i.e., at the −second and +second SC-FDMA symbols of the SC-FDMA symbol at which each reference signal is arranged).

Furthermore, the mobile station apparatus 200 first arranges the CQI and/or the PMI2, and the UL-SCH which have been multiplexed in the matrix in the horizontal axis direction (time direction), arranges them at all the SC-FDMA symbols in the horizontal axis direction (all the SC-FDMA symbols excluding the reference signals) and subsequently, arranges them in the vertical axis direction (referred to as time first mapping). At that time, the mobile station apparatus 200 skips elements of the matrix in which the RI and the PMI1 have been arranged, and arranges the CQI and/or the PMI2, and the UL-SCH which have been multiplexed.

Moreover, the mobile station apparatus 200 overwrites (also referred to as punctures) a part of the CQI and/or the PMI2, and the UL-SCH which have been multiplexed with the information indicating the ACK/NACK so that it is arranged by the arrangement method as shown in FIG. 8.

That is, a part of the CQI and/or the PMI2, and the UL-SCH which have been multiplexed is overwritten with the information indicating the ACK/NACK so that the information is arranged at the third, fifth, tenth, and twelfth SC-FDMA symbols (i.e., at the −first and +first SC-FDMA symbols of the SC-FDMA symbol at which each reference signal is arranged).

That is, in the mobile station apparatus 200 arranging the information indicating the ACK/NACK, some elements of the UL-SCH in the already occupied matrix are overwritten. In addition, such overwrite processing is also referred to as rearrangement processing.

The mobile station apparatus 200 arranges in the elements of the matrix the CQI and/or PMI, the UL-SCH, the RI, and the information indicating the ACK/NACK to which multiprocessing and rearrangement processing have been applied, and thus each UCI is arranged as shown in FIG. 8. Here, multiprocessing and rearrangement processing are also referred to as arrangement processing (mapping processing).

When at least one PDSCH in the SDCC is scheduled by the base station apparatus 100, the mobile station apparatus 200 arranges the UCI through the use of the second arrangement method as shown in FIG. 8. That is, the mobile station apparatus 200 transmits the UCI arranged through the use of the second arrangement method as shown in FIG. 8 to the base station apparatus 100 through the use of the PUSCH scheduled by the base station apparatus 100.

The mobile station apparatus 200 arranges the UCI through the use of the second arrangement method shown in FIG. 8 (the PMI1 is arranged close to the reference signal), and thus channel estimation accuracy for the PMI1 can be improved.

The base station apparatus 100 receives the UCI arranged by the second arrangement method by the mobile station apparatus 200. For example, the base station apparatus 100 extracts from the PUSCH the UCI arranged by the second arrangement method, and performs scheduling to the mobile station apparatus 200 based on the extracted UCI.

Furthermore, the second arrangement method for the UCI by the mobile station apparatus 200 will be described using FIG. 8.

In FIG. 8, first, the mobile station apparatus 200 performs multiprocessing of the CQI and/or the PMI2, and the UL-SCH. That is, the mobile station apparatus 200 performs multiprocessing of the CQI and/or the PMI2, and the UL-SCH, and generates the CQI and/or the PMI2, and the UL-SCH which have been multiplexed. In the multiprocessing, the mobile station apparatus 200 multiplexes the CQI and/or the PMI2, and the UL-SCH so that they are arranged by the arrangement method as shown in FIG. 8.

Subsequently, the mobile station apparatus 200 performs rearrangement processing (interleaving processing) of the CQI and/or the PMI2, the UL-SCH, the RI, the PMI1, and the information indicating the ACK/NACK which have been multiplexed. In the rearrangement processing, the mobile station apparatus 200 first prepares a matrix as shown in FIG. 8. It should be noted that the uplink demodulation reference signal is always arranged at the fourth and eleventh SC-FDMA symbols.

The mobile station apparatus 200 arranges the RI, the PMI1, and the information indicating the ACK/NACK in the matrix through the use of the arrangement method as shown in FIG. 8. That is, the RI and the PMI1 are arranged at the second, sixth, ninth, and thirteenth SC-FDMA symbols (i.e., at the −second and +second SC-FDMA symbols of the SC-FDMA symbol at which each reference signal is arranged). In addition, the information indicating the ACK/NACK is arranged at the third, fifth, tenth, and twelfth SC-FDMA symbols (i.e., at the −first and +first SC-FDMA symbols of the SC-FDMA symbol at which each reference signal is arranged).

Furthermore, the mobile station apparatus 200 arranges the CQI and/or the PMI2, and the UL-SCH which have been multiplexed in the matrix, first, in the horizontal axis direction (time direction), arranges them at all the SC-FDMA symbols in the horizontal axis direction (all the SC-FDMA symbols excluding the reference signals) and subsequently, arranges them in the vertical axis direction (referred to as time first mapping). At that time, the mobile station apparatus 200 skips elements of the matrix in which the RI, the PMI1, and the information indicating the ACK/NACK have been arranged, and arranges the CQI and/or the PMI2, and the UL-SCH which have been multiplexed.

The mobile station apparatus 200 arranges in the elements of the matrix the CQI and/or the PMI2, the UL-SCH, the RI, the PMI1, and the information indicating the ACK/NACK to which multiprocessing and rearrangement processing have been applied, and thus each UCI is arranged as shown in FIG. 8. Here, multiprocessing and rearrangement processing are also referred to as arrangement processing (mapping processing).

When at least one PDSCH in the SDCC is scheduled by the base station apparatus 100, the mobile station apparatus 200 arranges the UCI through the use of the second arrangement method as shown in FIG. 8. That is, the mobile station apparatus 200 transmits the UCI arranged through the use of the second arrangement method as shown in FIG. 8 to the base station apparatus 100 through the use of the PUSCH scheduled by the base station apparatus 100.

The mobile station apparatus 200 arranges the UCI through the use of the second arrangement method shown in FIG. 8, and thus can be eliminated the UCI (the CQI and/or the PMI2, and the UL-SCH) to be overwritten (punctured) in arranging control information in the HARQ (information indicating the ACK/NACK), and channel estimation accuracy for the PMI1 can also be improved.

The base station apparatus 100 receives the UCI arranged by the second arrangement method by the mobile station apparatus 200. For example, the base station apparatus 100 extracts from the PUSCH the UCI arranged by the second arrangement method, and performs scheduling to the mobile station apparatus 200 based on the extracted UCI.

As mentioned above, the mobile station apparatus 200 switches the arrangement methods for the UCI in accordance with the scheduling of the PDSCH by the base station apparatus 100. That is, the mobile station apparatus 200 can switch positions in arranging the UCI (SC-FDMA symbol) in accordance with the scheduling of the PDSCH by the base station apparatus 100. In addition, the mobile station apparatus 200 can switch orders in arranging the UCI in accordance with the scheduling of the PDSCH by the base station apparatus 100.

In addition, as mentioned above, the mobile station apparatus 200 can transmit the control information in the first HARQ or the control information in the second HARQ to the base station apparatus 100 in accordance with the scheduling of the PDSCH by the base station apparatus 100. That is, the mobile station apparatus 200 can arrange the control information in the first HARQ by the first arrangement method in accordance with the scheduling of the PDSCH by the base station apparatus 100, and can transmit it to the base station apparatus 100. Furthermore, the mobile station apparatus 200 can arrange the control information in the second HARQ by the second arrangement method in accordance with the scheduling of the PDSCH by the base station apparatus 100, and can transmit it to the base station apparatus 100. That is, it becomes possible to increase an amount of information of the control information in the HARQ that can be transmitted by the second arrangement method more than an amount of information of the control information in the HARQ that can be transmitted by the first arrangement method.

As described above, in the first embodiment, the base station apparatus 100 schedules the PDSCH to the mobile station apparatus 200, the mobile station apparatus 200 transmits the UCI arranged by the first arrangement method or the second arrangement method to the base station apparatus 100 in accordance with the scheduling of the PDSCH by the base station apparatus 100, and thus the base station apparatus 100 and the mobile station apparatus 200 can transmit and receive the UCI efficiently through the use of the radio resource.

The mobile station apparatus 200 switches the arrangement methods of the UCI in accordance with the scheduling of the PDSCH by the base station apparatus 100, and thus the base station apparatus 100 need not transmit the DCI, thus enabling to efficiently use the radio resource.

The mobile station apparatus 200 switches the arrangement methods of the UCI in accordance with the scheduling of the PDSCH by the base station apparatus 100, and thus can be selected an optimum arrangement method of the UCI in the mobile communication system in which carrier aggregation has been performed. That is, the mobile station apparatus 200 can use an optimum transmission method of the UCI in the mobile communication system in which carrier aggregation has been performed.

Meanwhile, the mobile station apparatus 200 switches the arrangement methods of the UCI in accordance with the scheduling of the PDSCH by the base station apparatus 100, and thus an arrangement method of the UCI in the conventional technology can be selected. That is, the mobile station apparatus 200 can secure consistency with the transmission method of the UCI in the conventional technology.

In addition, the present invention can also employ the following aspects. That is, a mobile communication system of the present invention is the mobile communication system in which a base station apparatus and a mobile station apparatus communicate with each other through the use of a plurality of CCs, and the mobile communication system is characterized in that the base station apparatus sets a particular DCC to the mobile station apparatus, the mobile station apparatus selects a first arrangement method for UCI when only a PDSCH in the particular DCC is scheduled by the base station apparatus, and that the mobile station apparatus selects a second arrangement method for the UCI when at least one PDSCH in DCCs other than the particular DCC is scheduled by the base station apparatus 100.

Furthermore, the mobile communication system of the present invention is characterized in that the mobile station apparatus transmits the UCI arranged by the selected arrangement method to the base station apparatus through the use of a PUSCH.

Moreover, a mobile station apparatus of the present invention is the mobile station apparatus in a mobile communication system in which a base station apparatus and the mobile station apparatus communicate with each other through the use of a plurality of CCs, and the mobile station apparatus is characterized by including means for switching arrangement methods for UCI in accordance with scheduling of a PDSCH by the base station apparatus.

In addition, a mobile station apparatus of the present invention is the mobile station apparatus in a mobile communication system in which a base station apparatus and the mobile station apparatus communicate with each other through the use of a plurality of CCs, and the mobile station apparatus is characterized by including: means for a particular DCC being set by the base station apparatus; means for selecting a first arrangement method for UCI when only a PDSCH in the particular DCC is scheduled by the base station apparatus; and means for selecting a second arrangement method for the UCI when at least one PDSCH in DCCs other than the particular DCC is scheduled by the base station apparatus 100.

In addition, the mobile station apparatus of the present invention is characterized by including means for transmitting the UCI to the base station apparatus through the use of the PUSCH.

In addition, a base station apparatus of the present invention is the base station apparatus in a mobile communication system in which the base station apparatus and a mobile station apparatus communicate with each other using a plurality of CCs, and the base station apparatus is characterized by including means for receiving, from the mobile station apparatus, UCI arranged by an arrangement method switched by the mobile station apparatus in accordance with scheduling of a PDSCH for the mobile station apparatus.

Furthermore, a base station apparatus of the present invention is the base station apparatus in a mobile communication system in which the base station apparatus and a mobile station apparatus communicate with each other through the use of a plurality of CCs, and the base station apparatus is characterized by including: means for setting a particular DCC to the mobile station apparatus; means for receiving from the mobile station apparatus UCI arranged by a first arrangement method selected by the mobile station apparatus when scheduling only a PDSCH in the particular DCC; and means for receiving from the mobile station apparatus the UCI arranged by a second arrangement method selected by the mobile station apparatus when scheduling at least one PDSCH in DCCs other than the particular DCC.

Moreover, the base station apparatus of the present invention is characterized by including means for receiving the UCI from the mobile station apparatus through the use of the PUSCH.

In addition, a communication method of the present invention is the communication method for a mobile station apparatus in a mobile communication system in which a base station apparatus and the mobile station apparatus communicate with each other through the use of a plurality of CCs, and the communication method is characterized in that the mobile station apparatus switches arrangement methods for UCI in accordance with scheduling of a PDSCH by the base station apparatus.

Furthermore, a communication method of the present invention is the communication method for a mobile station apparatus in a mobile communication system in which a base station apparatus and the mobile station apparatus communicate with each other using a plurality of CCs, and the communication method is characterized in that a particular DCC is set by the base station apparatus, the mobile station apparatus selects a first arrangement method for UCI when only a PDSCH in the particular DCC is scheduled by the base station apparatus, and that the mobile station apparatus selects a second arrangement method for the UCI when at least one PDSCH in DCCs other than the particular DCC is scheduled by the base station apparatus 100.

Moreover, a communication method of the present invention is the communication method for a base station apparatus in a mobile communication system in which the base station apparatus and a mobile station apparatus communicate with each other using a plurality of CCs, and the communication method is characterized in that the base station apparatus receives from the mobile station apparatus UCI arranged by an arrangement method switched by the mobile station apparatus in accordance with scheduling of a PDSCH to the mobile station apparatus.

In addition, a communication method of the present invention is the communication method for a base station apparatus in a mobile communication system in which the base station apparatus and a mobile station apparatus communicate with each other using a plurality of CCs, and the communication method is characterized in that the base station apparatus sets a particular DCC to the mobile station apparatus, the base station apparatus receives from the mobile station apparatus UCI arranged by a first arrangement method selected by the mobile station apparatus when scheduling only a PDSCH in the particular DCC, and that the base station apparatus receives from the mobile station apparatus the UCI arranged by a second arrangement method selected by the mobile station apparatus when scheduling at least one PDSCH in DCCs other than the particular DCC.

The embodiments described above are applied also to an integrated circuit/chip set mounted in the base station apparatus 100 and the mobile station apparatus 200. In addition, in the embodiments described above, a program for achieving each function inside the base station apparatus 100 and each function inside the mobile station apparatus 200 is recorded in a computer-readable recording medium, the program recorded in the recording medium is read into a computer system, and the program is executed, whereby control of the base station apparatus 100 and the mobile station apparatus 200 may be performed. It should be noted that a “computer system” referred to herein shall include hardwares, such as an OS and a peripheral device.

In addition, a “computer-readable recording medium” means a portable medium such as a flexible disk, a magnetic optical disk, a ROM, and a CD-ROM, and a memory storage such as a hard disk incorporated in the computer system. Furthermore, the “computer-readable recording medium” is configured also to include a medium that dynamically holds a program for a short time as a communication wire used when the program is transmitted via a communication line, such as a network like the Internet and a telephone line, and a medium that holds a program for a certain time like a volatile memory inside the computer system serving as a server or a client when the program is dynamically held for the short time. In addition, the above-described program may be the program for achieving a part of the above-mentioned functions and furthermore, it may be the program in which the above-mentioned functions can be achieved in combination with a program having been already recorded in the computer system.

Hereinbefore, the embodiments of the present invention have been mentioned in detail with reference to the drawings, but a specific configuration is not limited to the embodiments, and a design and the like in the scope not departing from the gist of the present invention are also included in the claims.

### DESCRIPTION OF SYMBOLS

100 Base station apparatus
101 Data control unit
102 Transmission data modulation unit
103 Radio unit
104 Scheduling unit
105 Channel estimation unit
106 Received data demodulation unit
107 Data extraction unit
108 Higher layer
109 Antenna
110 Radio resource control unit
200 Mobile station apparatus
201 Data control unit
202 Transmission data modulation unit
203 Radio unit
204 Scheduling unit
205 Channel estimation unit
206 Received data demodulation unit
207 Data extraction unit
208 Higher layer
209 Antenna
210 Radio resource control unit

1. A mobile station apparatus that transmits, to a base station apparatus through the use of a physical uplink shared channel, information indicating an ACK or NACK to a transport block transmitted by said base station apparatus, said mobile station apparatus comprising:
a unit that selects a first information indicating ACK or NACK in the case that said mobile station apparatus transmits, to said base station apparatus, said information indicating the ACK or NACK to said transport block transmitted in one component carrier;
a unit that selects a second information indicating ACK or NACK in the case that said mobile station apparatus transmits, to said base station apparatus, said information indicating the ACK or NACK to said transport block transmitted in a plurality of component carriers; and
a unit that transmits, to said base station apparatus through the use of said physical uplink shared channel, said selected first information indicating ACK or NACK or said selected second information indicating ACK or NACK.

2. A mobile station apparatus that transmits, to a base station apparatus through the use of a physical uplink shared channel, information indicating an ACK or NACK to a transport block transmitted by said base station apparatus, said mobile station apparatus comprising:
a unit that selects a first arrangement method in the case that said mobile station apparatus transmits, to said base station apparatus, said information indicating the ACK or NACK to said transport block transmitted in one component carrier;
a unit that selects a second arrangement method in the case that said mobile station apparatus transmits, to said base station apparatus, said information indicating the ACK or NACK to said transport block transmitted in a plurality of component carriers;
a unit that processes said information indicating the ACK or MACK through the use of said selected first arrangement method or said selected second arrangement method; and
a unit that transmits said processed information indicating the ACK or NACK to said base station apparatus through the use of said physical uplink shared channel.

3. A base station apparatus that receives from a mobile station apparatus through the use of a physical uplink shared channel information indicating an ACK or NACK to a transport block transmitted to said mobile station apparatus, said base station apparatus comprising:
a unit that transmits said transport block to said mobile station apparatus in one component carrier or a plurality of component carriers; and
a unit that receives, from said mobile station apparatus through the use of said physical uplink shared channel, a first information indicating ACK or NACK or a second information indicating ACK or NACK, wherein
the first information indicating ACK or NACK is selected the case that said base station apparatus transmits said transport block to said mobile station apparatus in one component carrier; and
the second information indicating ACK or NACK selected in the case that said base station apparatus transmits said transport block to said mobile station apparatus in the plurality of component carriers.

4.-8. (canceled)
